(19) United States
(12) Patent Application Publication
(10) Pub. No.: US 2026/0101241 A1
(43) Pub. Date: Apr. 9, 2026

(54) REFERENCE SIGNAL INDICATION FOR A CANDIDATE CELL IN L1/L2 MOBILITY

(71) Applicant: QUALCOMM Incorporated, San Diego, CA (US)

(72) Inventors: Fang YUAN, Beijing (CN); Yan ZHOU, San Diego, CA (US)

(21) Appl. No.: 19/115,138

(22) PCT Filed: Nov. 24, 2022
(86) PCT No.: PCT/CN2022/133864

§ 371 Date: Mar. 25, 2025

(51) Int. Cl. H04W 36/00; H04B 17/309; H04W 24/08; H04W 36/14; H04W 72/231

(52) U.S. Cl. CPC H04W 36/0058; H04B 17/347; H04W 24/08; H04W 36/14; H04W 72/231

(57) ABSTRACT

Methods, systems, and devices for level 1/level 2 wireless communications are described. In some examples, a user equipment (UE) may receive, from a first network entity, an indication of a reference signal associated with a second network entity. The UE may measure the reference signal associated with the second network entity to determine beam information, path loss information, or both, and may switch communications with the first network entity to the second network entity. In some other examples, the UE may detect beam failure based on one or more reference signals associated with the first network entity and may transmit a beam failure request indicating a reference signal associated with the second network entity. The UE may receive an indication for the UE to switch communications with the first network entity to the second network entity and may switch communications with the first network entity to the second network entity.

### CROSS REFERENCE

The present Application is a 371 national phase filing of International PCT Application No. PCT/CN2022/133864 by YUAN et al., entitled “REFERENCE SIGNAL INDICATION FOR A CANDIDATE CELL IN L1/L2 MOBILITY,” filed Nov. 24, 2022, which is assigned to the assignee hereof, and which is expressly incorporated by reference in its entirety herein.

### FIELD OF TECHNOLOGY

The following relates to wireless communications, including reference signal indication for a candidate cell in level 1 (L1)/level 2 (L2) mobility.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support reference signal indication for a candidate cell in level 1 (L1)/level 2 (L2) mobility. Generally, the techniques described herein may enable a user equipment (UE) to transmit, receive, or both, an indication of a reference signal associated with a candidate network entity (e.g., cell) in a L1 or L2 mobility scenario. In some examples, the UE may receive, from a first network entity in communication with the UE (e.g., an active serving cell), an indication of a reference signal associated with a second network entity (e.g., candidate cell). The UE may measure the reference signal associated with the second network entity to determine beam information, path loss information, timing information, or any combination thereof, associated with the second network entity. Accordingly, the UE may switch communications with the first network entity to the second network entity based on measuring the reference signal.

Additionally, or alternatively, the UE may detect beam failure based on one or more reference signals associated with the first network entity and may transmit, to the first network entity, a beam failure request (BFR) indicating a reference signal associated with the second network entity based on detecting the beam failure. The UE may receive, from the first network entity, control signaling in response to the beam failure request, the control signaling indicating for the UE to switch communications with the first network entity to the second network entity. Accordingly, the UE may switch communications with the first network entity to the second network entity based on receiving the control signaling.

A method for wireless communications at a UE is described. The method may include receiving, from a first network entity in communication with the UE, an indication of a reference signal associated with a second network entity, measuring the reference signal associated with the second network entity to determine beam information, path loss information, or both, associated with the second network entity, and switching communications with the first network entity to the second network entity based on measuring the reference signal.

An apparatus for wireless communications at a UE is described. The apparatus may include a processor, memory coupled with the processor, and instructions stored in the memory. The instructions may be executable by the processor to cause the apparatus to receive, from a first network entity in communication with the UE, an indication of a reference signal associated with a second network entity, measure the reference signal associated with the second network entity to determine beam information, path loss information, or both, associated with the second network entity, and switch communications with the first network entity to the second network entity based on measuring the reference signal.

Another apparatus for wireless communications at a UE is described. The apparatus may include means for receiving, from a first network entity in communication with the UE, an indication of a reference signal associated with a second network entity, means for measuring the reference signal associated with the second network entity to determine beam information, path loss information, or both, associated with the second network entity, and means for switching communications with the first network entity to the second network entity based on measuring the reference signal.

A non-transitory computer-readable medium storing code for wireless communications at a UE is described. The code may include instructions executable by a processor to receive, from a first network entity in communication with the UE, an indication of a reference signal associated with a second network entity, measure the reference signal associated with the second network entity to determine beam information, path loss information, or both, associated with the second network entity, and switch communications with the first network entity to the second network entity based on measuring the reference signal.

Some examples of the method, apparatuses, and non-transitory computer-readable medium described herein may further include operations, features, means, or instructions for receiving, from the first network entity, control signaling indicating for the UE to switch communications with the first network entity to the second network entity, where switching communications with the first network entity to the second network entity may be based on receiving the control signaling.

In some examples of the method, apparatuses, and non-transitory computer-readable medium described herein, the control signaling includes the indication of the reference signal associated with the second network entity.

In some examples of the method, apparatuses, and non-transitory computer-readable medium described herein, the control signaling may be DCI signaling or MAC-CE signaling.

In some examples of the method, apparatuses, and non-transitory computer-readable medium described herein, the UE receives the indication of the reference signal associated with the second network entity prior to receiving the control signaling.

In some examples of the method, apparatuses, and non-transitory computer-readable medium described herein, the indication of the reference signal associated with the second network entity may be received via DCI signaling, MAC-CE signaling, or RRC signaling.

In some examples of the method, apparatuses, and non-transitory computer-readable medium described herein, the indication of the reference signal includes an indication of a SSB, a CSI-RS, a TRS, an identifier associated with the second network entity, or any combination thereof.

In some examples of the method, apparatuses, and non-transitory computer-readable medium described herein, measuring the reference signal associated with the second network entity may include operations, features, means, or instructions for measuring the reference signal to determine timing information associated with the second network entity.

In some examples of the method, apparatuses, and non-transitory computer-readable medium described herein, the timing information may be downlink timing information associated with one or more uplink channels further associated with the second network entity.

In some examples of the method, apparatuses, and non-transitory computer-readable medium described herein, measuring the reference signal associated with the second network entity may include operations, features, means, or instructions for measuring the reference signal associated with the second network entity to determine the beam information associated with one or more uplink channels, one or more downlink channels, or both, further associated with the second network entity.

In some examples of the method, apparatuses, and non-transitory computer-readable medium described herein, measuring the reference signal associated with the second network entity may include operations, features, means, or instructions for measuring the reference signal associated with the second network entity to determine the path loss information associated with one or more uplink channels further associated with the second network entity.

A method for wireless communications at a first network entity is described. The method may include outputting, to a UE in communication with the first network entity, an indication of a reference signal associated with a second network entity, the reference signal further associated with beam information, path loss information, or both, associated with the second network entity and releasing communications with the UE based on outputting the indication.

An apparatus for wireless communications at a first network entity is described. The apparatus may include a processor, memory coupled with the processor, and instructions stored in the memory. The instructions may be executable by the processor to cause the apparatus to outputting, to a UE in communication with the first network entity, an indication of a reference signal associate with a second network entity, the reference signal further associated with beam information, path loss information, or both, associated with the second network entity and release communications with the UE based on outputting the indication.

Another apparatus for wireless communications at a first network entity is described. The apparatus may include means for outputting, to a UE in communication with the first network entity, an indication of a reference signal associated with a second network entity, the reference signal further associated with beam information, path loss information, or both, associated with the second network entity and means for releasing communications with the UE based on outputting the indication.

A non-transitory computer-readable medium storing code for wireless communications at a first network entity is described. The code may include instructions executable by a processor to outputting, to a UE in communication with the first network entity, an indication of a reference signal associate with a second network entity, the reference signal further associated with beam information, path loss information, or both, associated with the second network entity and release communications with the UE based on outputting the indication.

In some examples of the method, apparatuses, and non-transitory computer-readable medium described herein, outputting control signaling indicating for the UE to switch communications with the first network entity to the second network entity, where releasing communications with the UE may be based on outputting the control signaling.

In some examples of the method, apparatuses, and non-transitory computer-readable medium described herein, the control signaling includes the indication of the reference signal associated with the second network entity.

In some examples of the method, apparatuses, and non-transitory computer-readable medium described herein, the control signaling may be DCI signaling or MAC-CE signaling.

In some examples of the method, apparatuses, and non-transitory computer-readable medium described herein, the first network entity outputs the indication of the reference signal associated with the second network entity prior to outputting the control signaling.

In some examples of the method, apparatuses, and non-transitory computer-readable medium described herein, the indication of the reference signal associated with the second network entity may be outputted via DCI signaling, MAC-CE signaling, or RRC signaling.

In some examples of the method, apparatuses, and non-transitory computer-readable medium described herein, the indication of the reference signal includes an indication of a SSB, a CSI-RS, a TRS, an identifier associated with a BWP further associated with the second network entity, a cell identifier associated with the second network entity, or any combination thereof.

In some examples of the method, apparatuses, and non-transitory computer-readable medium described herein, the reference signal associated with the second network entity may be further associated with timing information associated with the second network entity.

In some examples of the method, apparatuses, and non-transitory computer-readable medium described herein, the timing information may be downlink timing information associated with one or more uplink channels further associated with the second network entity.

In some examples of the method, apparatuses, and non-transitory computer-readable medium described herein, the beam information may be associated with one or more uplink channels, one or more downlink channels, or both, further associated with the second network entity.

In some examples of the method, apparatuses, and non-transitory computer-readable medium described herein, the path loss information may be associated with one or more uplink channels further associated with the second network entity.

A method for wireless communications at a UE is described. The method may include detecting beam failure based on one or more reference signals associated with a first network entity, where the UE is in communication with the first network entity, transmitting, to the first network entity, a BFR indicating a reference signal associated with a second network entity based on detecting the beam failure, receiving, from the first network entity, control signaling in response to the BFR, the control signaling indicating for the UE to switch communications with the first network entity to the second network entity, and switching communications with the first network entity to the second network entity based on receiving the control signaling.

An apparatus for wireless communications at a UE is described. The apparatus may include a processor, memory coupled with the processor, and instructions stored in the memory. The instructions may be executable by the processor to cause the apparatus to detect beam failure based on one or more reference signals associated with a first network entity, where the UE is in communication with the first network entity, transmit, to the first network entity, a BFR indicating a reference signal associated with a second network entity based on detecting the beam failure, receive, from the first network entity, control signaling in response to the BFR, the control signaling indicating for the UE to switch communications with the first network entity to the second network entity, and switch communications with the first network entity to the second network entity based on receiving the control signaling.

Another apparatus for wireless communications at a UE is described. The apparatus may include means for detecting beam failure based on one or more reference signals associated with a first network entity, where the UE is in communication with the first network entity, means for transmitting, to the first network entity, a BFR indicating a reference signal associated with a second network entity based on detecting the beam failure, means for receiving, from the first network entity, control signaling in response to the BFR, the control signaling indicating for the UE to switch communications with the first network entity to the second network entity, and means for switching communications with the first network entity to the second network entity based on receiving the control signaling.

A non-transitory computer-readable medium storing code for wireless communications at a UE is described. The code may include instructions executable by a processor to detect beam failure based on one or more reference signals associated with a first network entity, where the UE is in communication with the first network entity, transmit, to the first network entity, a BFR indicating a reference signal associated with a second network entity based on detecting the beam failure, receive, from the first network entity, control signaling in response to the BFR, the control signaling indicating for the UE to switch communications with the first network entity to the second network entity, and switch communications with the first network entity to the second network entity based on receiving the control signaling.

Some examples of the method, apparatuses, and non-transitory computer-readable medium described herein may further include operations, features, means, or instructions for receiving second control signaling indicating the one or more reference signals associated with the first network entity and indicating a set of candidate reference signals associated with a set of candidate network entities, the set of candidate network entities including at least the second network entity.

Some examples of the method, apparatuses, and non-transitory computer-readable medium described herein may further include operations, features, means, or instructions for selecting the reference signal associated with the second network entity from the set of candidate reference signals, where transmitting the BFR may be based on the selecting.

Some examples of the method, apparatuses, and non-transitory computer-readable medium described herein may further include operations, features, means, or instructions for measuring each reference signal from the set of candidate reference signals associated with the set of candidate network entities, where selecting the reference signal associated with the second network entity may be based on the measuring.

Some examples of the method, apparatuses, and non-transitory computer-readable medium described herein may further include operations, features, means, or instructions for measuring the reference signal associated with the second network entity to determine beam information, path loss information, timing information, or any combination thereof, associated with the second network entity.

In some examples of the method, apparatuses, and non-transitory computer-readable medium described herein, measuring the reference signal associated with the second network entity may include operations, features, means, or instructions for measuring the reference signal associated with the second network entity to determine the beam information associated with one or more uplink channels, one or more downlink channels, or both, further associated with the second network entity.

In some examples of the method, apparatuses, and non-transitory computer-readable medium described herein, measuring the reference signal associated with the second network entity may include operations, features, means, or instructions for measuring the reference signal associated with the second network entity to determine the path loss information associated with one or more uplink channels further associated with the second network entity.

In some examples of the method, apparatuses, and non-transitory computer-readable medium described herein, measuring the reference signal associated with the second network entity may include operations, features, means, or instructions for measuring the reference signal associated with the second network entity to determine the downlink timing information associated with one or more uplink channels further associated with the second network entity.

In some examples of the method, apparatuses, and non-transitory computer-readable medium described herein, the BFR includes an indication of an identifier associated with the second network entity, an index associated with the reference signal associated with the second network entity, or both.

In some examples of the method, apparatuses, and non-transitory computer-readable medium described herein, the BFR may be transmitted via MAC-CE signaling or PRACH signaling.

In some examples of the method, apparatuses, and non-transitory computer-readable medium described herein, the control signaling in response to the BFR may be a BFR response or a cell switching command.

In some examples of the method, apparatuses, and non-transitory computer-readable medium described herein, the cell switching command may be received via L1 signaling or L2 signaling.

Some examples of the method, apparatuses, and non-transitory computer-readable medium described herein may further include operations, features, means, or instructions for receiving second control signaling indicating one or more resources associated with the BFR, where the BFR may be transmitted via the one or more resources.

Some examples of the method, apparatuses, and non-transitory computer-readable medium described herein may further include operations, features, means, or instructions for measuring the one or more reference signals associated with the first network entity, where detecting the beam failure may be based on the measuring.

A method for wireless communications at a first network entity is described. The method may include obtaining, from a UE in communication with the first network entity, a BFR indicating a reference signal associated with a second network entity, outputting control signaling in response to the BFR, the control signaling indicating for the UE to switch communications with the first network entity to the second network entity, and releasing communications with the UE based on outputting the control signaling.

An apparatus for wireless communications at a first network entity is described. The apparatus may include a processor, memory coupled with the processor, and instructions stored in the memory. The instructions may be executable by the processor to cause the apparatus to obtain, from a UE in communication with the first network entity, a BFR indicating a reference signal associated with a second network entity, outputting control signal in response to the BFR, the control signaling indicating for the UE to switch communications with the first network entity to the second network entity, and release communications with the UE based on outputting the control signaling.

Another apparatus for wireless communications at a first network entity is described. The apparatus may include means for obtaining, from a UE in communication with the first network entity, a BFR indicating a reference signal associated with a second network entity, means for outputting control signaling in response to the BFR, the control signaling indicating for the UE to switch communications with the first network entity to the second network entity, and means for releasing communications with the UE based on outputting the control signaling.

A non-transitory computer-readable medium storing code for wireless communications at a first network entity is described. The code may include instructions executable by a processor to obtain, from a UE in communication with the first network entity, a BFR indicating a reference signal associated with a second network entity, outputting control signal in response to the BFR, the control signaling indicating for the UE to switch communications with the first network entity to the second network entity, and release communications with the UE based on outputting the control signaling.

In some examples of the method, apparatuses, and non-transitory computer-readable medium described herein, outputting second control signaling indicating one or more reference signals associated with the first network entity and indicating a set of candidate reference signals associated with a set of candidate network entities, the set of candidate network entities including at least the second network entity.

In some examples of the method, apparatuses, and non-transitory computer-readable medium described herein, the BFR includes an indication of an identifier associated with the second network entity, an index associated with the reference signal associated with the second network entity, or both.

In some examples of the method, apparatuses, and non-transitory computer-readable medium described herein, the BFR may be obtained via a MAC-CE or PRACH signaling.

In some examples of the method, apparatuses, and non-transitory computer-readable medium described herein, the control signaling in response to the BFR may be a BFR response or a cell switching command.

In some examples of the method, apparatuses, and non-transitory computer-readable medium described herein, the cell switching command may be outputted via L1 signaling or L2 signaling.

Some examples of the method, apparatuses, and non-transitory computer-readable medium described herein may further include operations, features, means, or instructions for transmitting second control signaling indicating one or more resources associated with the BFR, where the BFR may be obtained via the one or more resources.

### BRIEF DESCRIPTION OF THE DRAWINGS

FIG. 1 illustrates an example of a wireless communications system that supports reference signal indication for a candidate cell in level 1 (L1)/level 2 (L2) mobility in accordance with one or more aspects of the present disclosure.

FIG. 2 illustrates an example of a wireless communications system that supports reference signal indication for a candidate cell in L1/L2 mobility in accordance with one or more aspects of the present disclosure.

FIG. 3 illustrates an example of a process flow that supports reference signal indication for a candidate cell in L1/L2 mobility in accordance with one or more aspects of the present disclosure.

FIG. 4 illustrates an example of a process flow that supports reference signal indication for a candidate cell in L1/L2 mobility in accordance with one or more aspects of the present disclosure.

FIGS. 5 and 6 illustrate block diagrams of devices that support reference signal indication for a candidate cell in L1/L2 mobility in accordance with one or more aspects of the present disclosure.

FIG. 7 illustrates a block diagram of a communications manager that supports reference signal indication for a candidate cell in L1/L2 mobility in accordance with one or more aspects of the present disclosure.

FIG. 8 illustrates a diagram of a system including a device that supports reference signal indication for a candidate cell in L1/L2 mobility in accordance with one or more aspects of the present disclosure.

FIGS. 9 and 10 illustrate block diagrams of devices that support reference signal indication for a candidate cell in L1/L2 mobility in accordance with one or more aspects of the present disclosure.

FIG. 11 illustrates a block diagram of a communications manager that supports reference signal indication for a candidate cell in L1/L2 mobility in accordance with one or more aspects of the present disclosure.

FIG. 12 illustrates a diagram of a system including a device that supports reference signal indication for a candidate cell in L1/L2 mobility in accordance with one or more aspects of the present disclosure.

FIGS. 13 through 16 illustrate flowcharts showing methods that support reference signal indication for a candidate cell in L1/L2 mobility in accordance with one or more aspects of the present disclosure.

### DETAILED DESCRIPTION

In some wireless communications systems, a user equipment (UE) may be mobile, such that the UE may move between coverage areas of multiple network entities (e.g., servings cells). In such cases, the UE may be configured (e.g., pre-configured) with a set of candidate network entities (e.g., candidate serving cells) that may be associated with a set of coverage areas that the UE may move between. That is, the UE may communicate with a first network entity (e.g., an active service cell) and switch to communicating with a second network entity, which may be a candidate network entity from the set of candidate network entities, based on mobility of the UE (e.g., based on movement of the UE). In such cases, the UE may receive multiple signals (e.g., level 1 (L1)/level 2 (L2) signaling) configuring communications with the second network entity, such as a transmission configuration indication (TCI) state activation (e.g., indication), a path loss reference signal activation, signaling associated with timing advance (TA) management, or the like thereof, resulting in increased overhead and latency.

Accordingly, techniques described herein may enable a UE to transmit, receive, or both, an indication of a reference signal associated with a candidate network entity (e.g., in a L1 or L2 mobility scenario), such that the UE may perform one or more measurements based on the reference signal. In some examples, a first network entity (e.g., active serving cell) may transmit, to the UE, an indication of a reference signal associated with a second network entity (e.g., candidate serving cell), such that the UE may measure the reference signal to determine beam information, pathloss information, timing information, or any combination thereof, associated with the second network entity. In such cases, the UE may switch to communicating with the second network entity based on performing the one or more measurements. Additionally, or alternatively, the UE may be configured with a set of beam detection reference signals associated with the first network entity and a set of candidate reference signals associated with a set of candidate network entities, including the second network entity. In such cases, the UE may detect beam failure based on the set of beam detection reference signals and may transmit a beam failure request (BFR) to the first network entity indicating a reference signal from the set of candidate reference signals and an indication of the associated network entity, such as the second network entity. Additionally, the first network entity may transmit a BFR response (e.g., or cell switch command) indicating for the UE to switch to communicating with the second network entity. In some examples, the UE may determine beam information, pathloss information, timing information, or any combination thereof, associated with the second network entity based on the reference signal indicated in the BFR Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to reference signal indication for a candidate cell in L1/L2 mobility.

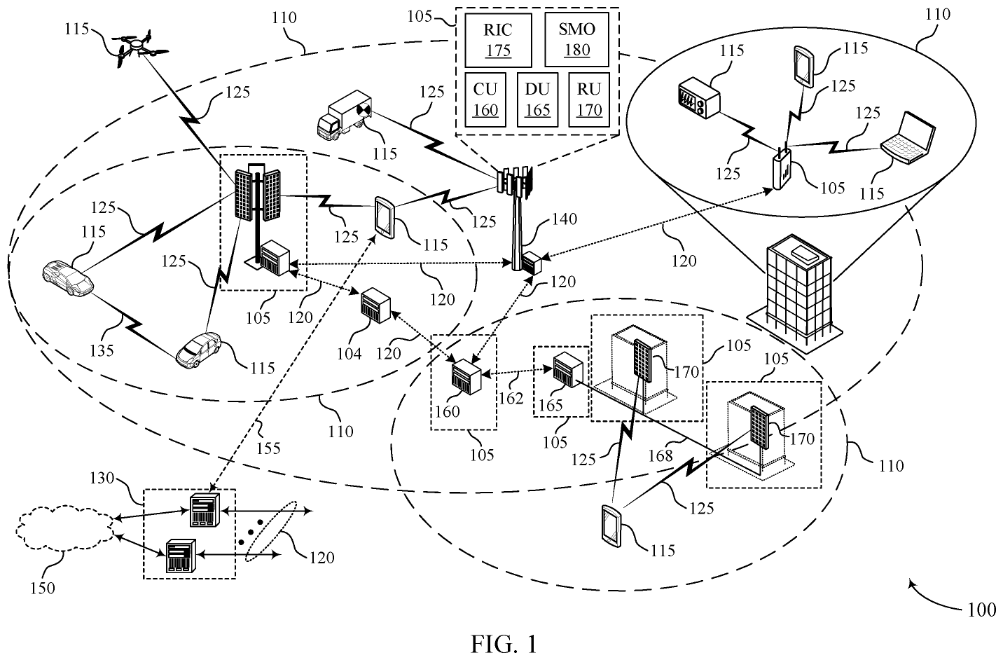

FIG. 1 illustrates an example of a wireless communications system 100 that supports reference signal indication for a candidate cell in L1/L2 mobility in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support reference signal indication for a candidate cell in L1/L2 mobility as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the wireless communications system 100 may support reference signal indication for a candidate cell in L1/L2 mobility. That is, techniques described herein may enable a UE 115 to transmit, receive, or both, an indication of a reference signal associated with a candidate network entity 105 (e.g., in a L1 or L2 mobility scenario), such that the UE 115 may perform one or more measurements based on the reference signal. In some examples, a first network entity 105 (e.g., active serving cell) may transmit, to the UE 115, an indication of a reference signal associated with a second network entity 105 (e.g., candidate serving cell), such that the UE 115 may measure the reference signal to determine beam information, pathloss information, timing information, or any combination thereof, associated with the second network entity 105. In such cases, the UE 115 may switch to communicating with the second network entity based on performing the one or more measurements. In some examples, the UE 115 may receive, from the first network entity 105, control signaling (e.g., a cell switch command) indicating for the UE 115 to switch communications with the first network entity 105 to the second network entity 105, such that the UE 115 may switch communications based on the control signaling.

Additionally, or alternatively, the UE 115 may receive, from the first network entity 105, an indication of a set of beam detection reference signals associated with the first network entity 105 and a set of candidate reference signals associated with a set of candidate network entities 105, including the second network entity 105. In such cases, the UE 115 may detect beam failure based on the set of beam detection reference signals and may transmit a beam failure request (BFR) to the first network entity 105 indicating a reference signal from the set of candidate reference signals and an indication of the associated candidate network entity 105, such as the second network entity 105. Additionally, the first network 105 entity may transmit a BFR response (e.g., or cell switch command) indicating for the UE 115 to switch to communicating with the second network entity 105. In some examples, the UE 115 may determine beam information, pathloss information, timing information, or any combination thereof, associated with the second network entity based on the reference signal indicated in the BFR.

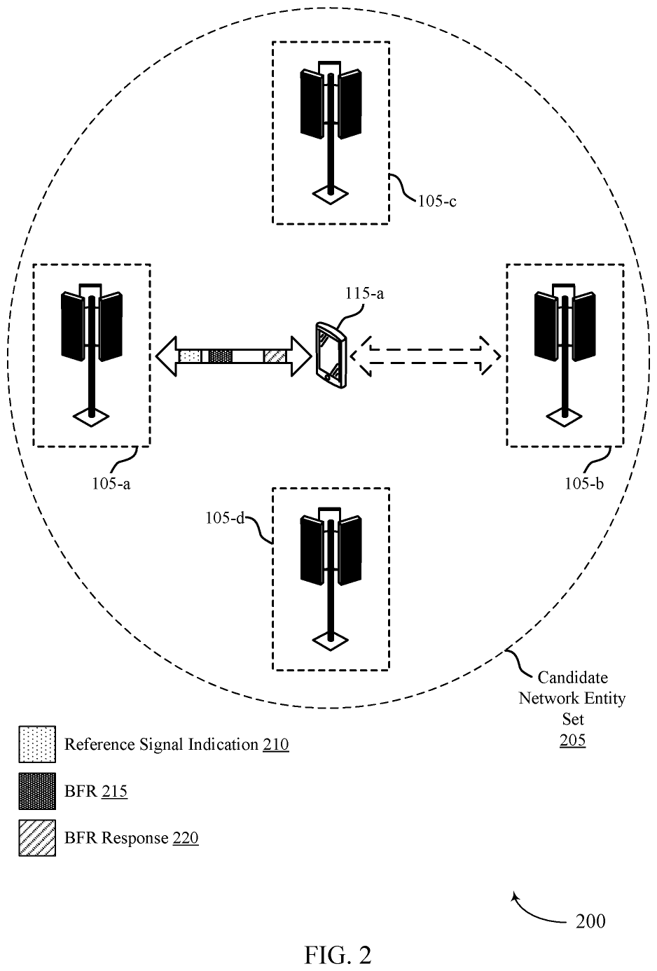

FIG. 2 illustrates an example of a wireless communications system 200 that supports reference signal indication for a candidate cell in L1/L2 mobility in accordance with one or more aspects of the present disclosure. In some examples, the wireless communications system 200 may implement or be implemented by aspects of the wireless communications system 100. For example, the wireless communications system 200 may include one or more network entities 105 (e.g., a network entity 105-a, a network entity 105-b, a network entity 105-c, and a network entity 105-d) and one or more UEs 115 (e.g., a UE 115-a), which may be examples of the corresponding devices as described with reference to FIG. 1. In the example of FIG. 2, the network entities 105 may be examples of a CU 160, a DU 165, an RU 170, a base station 140, an IAB node 104, or one or more other network nodes as described with reference to FIG. 1. The wireless communications system 200 may include features for reference signal indication for a candidate network entity 105 in an L1/L2 mobility scenario.

In some cases, the wireless communications system 200 may support UE 115 mobility scenarios (e.g., L1/L2 mobility scenarios). In such cases, a UE 115, such as the UE 115-a, may be mobile, such that the UE 115-a may move between coverage areas associated with multiple network entities 105 (e.g., serving cells), such as a network entity 105-a, a network entity 105-b, a network entity 105-c, and a network entity 105-d. That is, the UE 115-a may move such that the UE 115-a may exist in one or more coverage areas associated with the multiple network entities 105 at a given time. In some examples, one or more network entities 105 of the multiple network entities 105 may communicate via a same frequency or different frequencies.

In some examples, the UE 115-a may be configured (e.g., pre-configured) with a candidate network entity set 205 (e.g., candidate serving cells). That is, the UE 115-a may receive control signaling (e.g., from an active serving cell, such as the network entity 105-a) indicating a set of network entities 105, which may be referred to as candidate network entities 105, that the UE 115-a may switch between (e.g., be capable of switching communications between), which may be referred to as the candidate network entity set 205. In the context of FIG. 2, the candidate network entity set 205 may include the network entity 105-a, the network entity 105-b, the network entity 105-c, and the network entity 105-d.

Accordingly, the UE 115-a may receive control signaling (e.g., from the active serving cell) configuring, maintaining, or both, the candidate network entities 105 of the candidate network entity set 205 to support application (e.g., fast application) of configurations associated with each candidate network entity 105. In such examples, the UE 115-a may support dynamic switching (e.g., dynamic switching mechanisms) among the candidate network entities 105 (e.g., including SpCell and SCell) based on control signaling (e.g., L1/L2 signaling). In some examples, the UE 115-a may support dynamic switching in a scenario (e.g., standalone, carrier aggregation (CA), new radio dual connectivity (NR-DC)) such that an active network entity 105 (e.g., active serving cell) changes within a configured group (CG), a scenario associated with intra-DU switching, a scenario associated with intra-CU inter-DU switching (e.g., for standalone and CA), a scenario associated with intra-frequency switching, a scenario associated with inter-frequency switching, a scenario where one or more candidate network entities 105 are associated with FR1, FR2, or both, a scenario where an active network entity 105 and a candidate network entity 105 are synchronized, a scenario where an active network entity 105 and a candidate network entity 105 are not synchronized, or any combination thereof.

In some examples, the UE 115-a may receive multiple (e.g., separate) control signals (e.g., L1/L1 signaling) associated with beam management, TA management, pathloss management, CU-DU interface management, or the like thereof. For example, the UE 115-a may receive a TCI state activation, a pathloss reference signal activation, signaling associated with TA management, or any combination thereof, which may result increased overhead and latency.

Accordingly, techniques described herein may support latency reduction through measurement of an indicated reference signal associated with a candidate network entity 105 to determine beam information, pathloss information, timing information, or any combination thereof. For example, continuing with the example of FIG. 2, the UE 115-a may receive control signaling indicating (e.g., configuring) the candidate network entity set 205, including the network entity 105-a, the network entity 105-b, the network entity 105-c, and the network entity 105-d. The UE 115-a may communicate with the network entity 105-a (e.g., active serving cell) and may receive, from the network entity 105-a, a reference signal indication 210 including an indication of a reference signal associated with a candidate network entity 105, such as the network entity 105-b, from the candidate network entity set 205. In some examples, the network entity 105-a and the network entity 105-b may be associated with a same frequency (e.g., inter-frequency switching) or may be associated with different frequencies (e.g., intra-frequency switching).

In some cases, the reference signal indication 210 may include an indication of the reference signal associated with the network entity 105-b, an identifier associated with the network entity 105-b, or both. For example, the reference signal indication 210 may include an indication of a synchronization signal block (SSB), a channel state information reference signal (CSI-RS), a tracking reference signal (TRS) (e.g., a CSI-RS configured for tracking, mobility, or beam management), a cell identifier associated with the network entity 105-b, a BWP identifier associated with the network entity 105-b, or any combination thereof. In some examples, the indication may include one or more indices associated with the reference signal, one or more indices associated with the identifier associated with the network entity 105-b, or both. The cell index may be a serving cell index, or a physical cell index.

Accordingly, the UE 115-a may measure the indicated reference signal for beam information, path loss information, reference timing information, or the like thereof (e.g., or any combination thereof). For example, the UE 115-a may measure the indicated reference signal to determine beam information associated with one or more uplink channels, one or more downlink channels, or both, (e.g., all uplink and downlink channels) associated with the network entity 105-b (e.g., prior to any TCI activation/indication). Additionally, or alternatively, the UE 115-a may measure the indicated reference signal to determine path loss information associated with one or more uplink channels (e.g., all uplink channels) associated with the network entity 105-b (e.g., prior to any path loss reference signal activation/indication). Additionally, or alternatively, the UE 115-a may measure the indicated reference signal to determine downlink reference timing information associated with one or more uplink channels (e.g., all uplink channels) associated with the network entity 105-b (e.g., prior to any TA management).

As such, the UE 115-a may switch from communicating with the network entity 105-a to communicating with the network entity 105-b based on the measurements. Additionally, or alternatively, the UE 115-a may receive, from the network entity 105-a, control signaling (e.g., L1 or L2 signaling) indicating for the UE 115-a to switch from communicating with the network entity 105-a to communicating with the network entity 105-b (e.g., a cell switch command), such that the UE 115-a may switch from communicating with the network entity 105-a to communicating with the network entity 105-b based on the measurements, the control signaling, or both.

In some examples, the UE 115-a may receive the indication of the reference signal associated with the network entity 105-b prior to receiving the control signaling indicating for the UE 115-a to switch communications (e.g., L1 or L2 cell switch command). In such cases, the indication of the reference signal associated with the network entity 105-b may be communicated via downlink control information (DCI) or MAC-CE signaling. In some other examples, the control signaling indicating for the UE 115-a to switch communications (e.g., L1 or L2 cell switch command) may include the indication of the reference signal associated with the network entity 105-b. In such cases, the control signaling may be communicated via DCI, MAC-CE signaling, or RRC signaling.

Additionally, or alternatively, techniques described herein may support latency reduction through transmission of a BFR 215 (e.g., as part of a beam failure procedure) indicating a reference signal associated with a candidate network entity 105. For example, the UE 115-a may receive (e.g., from the network entity 105-a) control signaling indicating (e.g., configuring) a beam failure recovery procedure associated with the candidate network entities 105 from the candidate network entity set 205. In some cases, the UE 115-a may receive (e.g., from the network entity 105-a) an indication of a set of beam detection reference signals, a set of candidate reference signals (e.g., candidate beam reference signals), or both. The beam detection reference signals may include reference signals associated with (e.g., measured on/from) the network entity 105-a (e.g., the active serving cell) and the candidate reference signals may include reference signals associated with the candidate network entities 105 from the candidate network entity set 205.

As such, the UE 115-a may measure one or more reference signals from the set of beam detection reference signals and may detect beam failure (e.g., a beam failure event) associated with the network entity 105-a based on the measurements. For example, the UE 115-a may detect beam failure based on a value of one or more measurements failing to exceed a threshold or exceeding a threshold. The UE 115-a may detect the beam failure and may transmit a BFR 215 (e.g., triggered by the beam failure detection). The BFR 215 may include an indication of a reference signal and a candidate network entity 105 associated with the reference signal. That is, the UE 115-a may measure one or more reference signals of the set of candidate beam reference signals and may select a reference signal (e.g., to indicate via the BFR) based on the measurements. For example, the UE 115-a may select a reference signal from the set of candidate beam reference signals based on one or more measured characteristics associated with the reference signal.

In some examples, the indication may include a reference signal index associated with the reference signal, an identifier (e.g., cell index) associated with the candidate network entity 105, or both. Additionally, or alternatively, the BFR 215 may be communicated via MAC-CE signaling or physical random access channel (PRACH) signaling.

In some examples, the UE 115-a may receive (e.g., from the network entity 105-a), an indication of one or more resources (e.g., scheduling request resources) associated with the BFR 215. That is, the UE 115-a may transmit the BFR 215 via the indicated one or more resources.

Additionally, the UE 115-a may switch from communicating with the network entity 105-a to communicating with the network entity 105-b. In some examples, the UE 115-a may switch from communicating with the network entity 105-a to communicating with the network entity 105-b based on transmitting the BFR 215. In some other examples, the UE 115-a may switch from communicating with the network entity 105-a to communicating with the network entity 105-b based on receiving a BFR response 220 (e.g., from the network entity 105-a). In some examples, the BFR response 220 may include an acknowledgement message associated with the BFR. Additionally, or alternatively, the BFR response 220 may include an indication of a reference signal associated with a candidate network entity 105 (e.g., a same reference signal as the reference signal indicated via the BFR 215 or a different reference signal as the reference signal indicated via the BFR 215). In some other examples, the UE 115-a may switch from communicating with the network entity 105-a to communicating with the network entity 105-b based on receiving control signaling indicating for the UE 115-a to switch communications (e.g., L1 or L2 cell switch command).

In some examples (e.g., until new signaling, such as a beam indication, a path loss indication, or TA management signaling, is indicated for the network entity 105-b), the UE 115-a may measure the reference signal indicated via the BFR 215 for beam information, path loss information, reference timing information, or the like thereof (e.g., or the combination thereof). For example, the UE 115-a may measure the indicated reference signal to determine beam information associated with one or more uplink channels, one or more downlink channels, or both, (e.g., all uplink and downlink channels) associated with the network entity 105-b (e.g., prior to any TCI activation/indication). Additionally, or alternatively, the UE 115-a may measure the indicated reference signal to determine path loss information associated with one or more uplink channels (e.g., all uplink channels) associated with the network entity 105-b (e.g., prior to any path loss reference signal activation/indication). Additionally, or alternatively, the UE 115-a may measure the indicated reference signal to determine downlink reference timing information associated with one or more uplink channels (e.g., all uplink channels) associated with the network entity 105-b (e.g., prior to any TA management).

While much of the present disclosure is described in the context of a candidate network entity set 205 including four network entities 105, this is solely for illustrative purposes, and is not to be regarded as a limitation of the present disclosure. In this regard, candidate network entity sets 205 may include any quantity of wireless devices, including, but not limited to, network entities 105, UEs 115, or the like thereof.

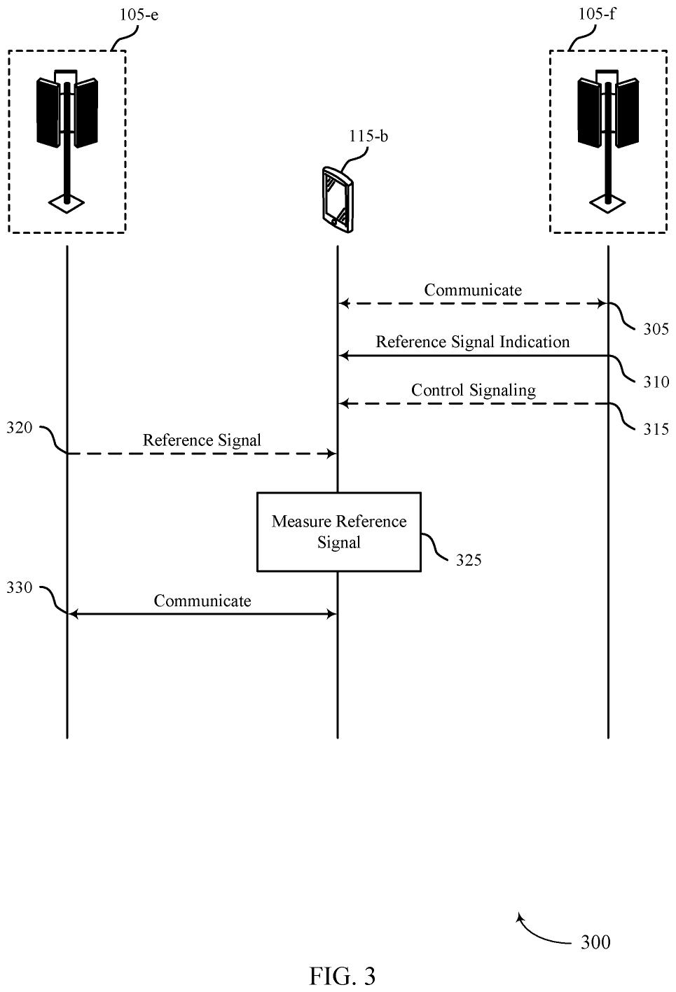

FIG. 3 illustrates an example of a process flow 300 that supports reference signal indication for a candidate cell in L1/L2 mobility in accordance with one or more aspects of the present disclosure. In some examples, the process flow 300 may implement or be implemented by aspects of the wireless communications system 100 and the wireless communications system 200. For example, the process flow 300 may include one or more network entities 105 (e.g., a network entity 105-e and a network entity 105-f) and one or more UEs 115 (e.g., a UE 115-b), which may be examples of the corresponding devices as described with reference to FIG. 1. In the example of FIG. 3, the network entities 105 may be examples of a CU 160, a DU 165, an RU 170, a base station 140, an IAB node 104, or one or more other network nodes as described with reference to FIG. 1. The process flow 300 may include features for measuring an indicated reference signal associated with a candidate network entity 105 to determine beam information, pathloss information, timing information, or any combination thereof.

In some examples, at 305, a UE 115-b may communicate with a network entity 105-f (e.g., an active serving cell).

At 310, the UE 115-b may receive, from the network entity 105-f, an indication of a reference signal associated with a network entity 105-e. In some examples, the network entity 105-e may be a candidate network entity 105 from a set of candidate network entities 105 associated with the UE 115-b (e.g., including at least the network entity 105-e and the network entity 105-f). In some examples, the UE 115-b may receive the indication of the reference signal associated with the network entity 105-e prior to receiving control signaling indicating for the UE 115-b to switch communications. In such cases, the indication of the reference signal may be communicated via DCI signaling, MAC-CE signaling, or RRC signaling.

In some examples, at 315, the UE 115-b may receive, from the network entity 105-f, the control signaling indicating for the UE 115-b to switch communications with the network entity 105-f to the network entity 105-e (e.g., a cell switch command). In some cases, the control signaling may include the indication of the reference signal associated with the network entity 105-e. In some examples, the control signaling may be DCI signaling or MAC-CE signaling.

In some cases, at 320, the UE 115-b may receive, from the network entity 105-e, the indicated reference signal.

At 325, the UE 115-b may measure the indicated reference signal associated with the network entity 105-e to determine beam information, path loss information, or both, associated with the network entity 105-e. For examples, the UE 115-b may measure the indicated reference signal associated with the network entity 105-e to determine beam information associated with one or more uplink channels, one or more downlink channels, or both, associated with the network entity 105-e. Additionally, or alternatively, the UE 115-b may measure the indicated reference signal associated with the network entity 105-e to determine path loss information associated with one or more uplink channels associated with the network entity 105-e.

Additionally, or alternatively, the UE 115-b may measure the indicated reference signal associated with the network entity 105-e to determine timing information associated with the network entity 105-e. For example, the UE 115-b may measure the indicated reference signal associated with the network entity 105-e to determine timing information associated with one or more uplink channels associated with the network entity 105-e.

At 330, the UE 115-b may switch communications with the network entity 105-f to the network entity 105-e based on measuring the reference signal.

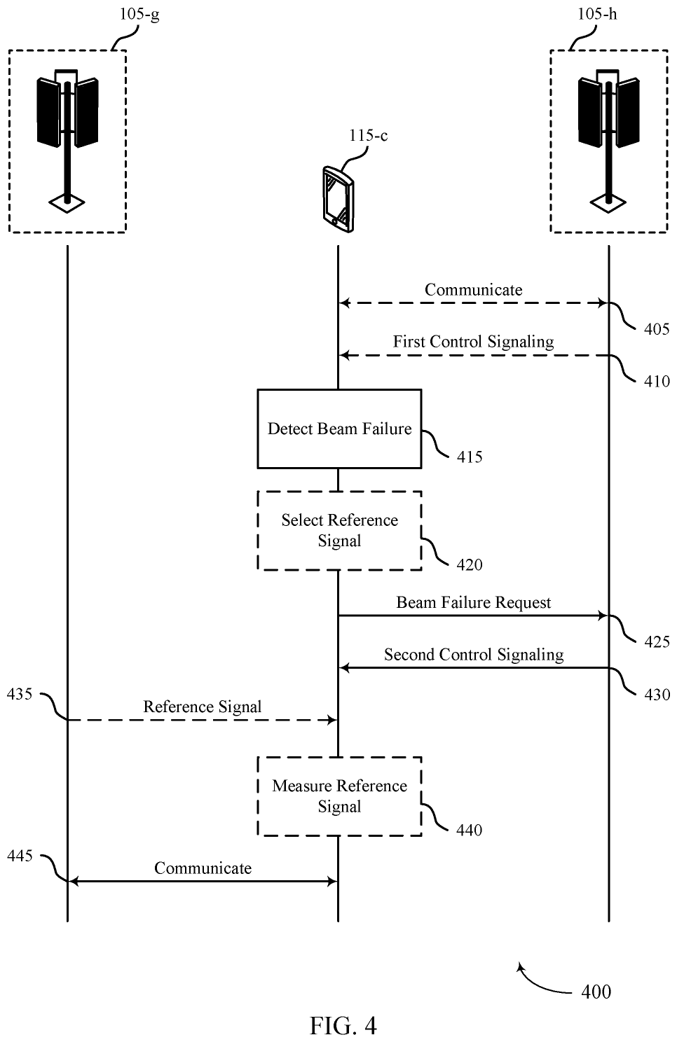

FIG. 4 illustrates an example of a process flow 400 that supports reference signal indication for a candidate cell in L1/L2 mobility in accordance with one or more aspects of the present disclosure. In some examples, the process flow 400 may implement or be implemented by aspects of the wireless communications system 100, the wireless communications system 200, and the process flow 300. For example, the process flow 400 may include one or more network entities 105 (e.g., a network entity 105-g and a network entity 105-h) and one or more UEs 115 (e.g., a UE 115-c), which may be examples of the corresponding devices as described with reference to FIG. 1. In the example of FIG. 4, the network entities 105 may be examples of a CU 160, a DU 165, an RU 170, a base station 140, an IAB node 104, or one or more other network nodes as described with reference to FIG. 1. The process flow 400 may include features for transmitting a BFR indicating a reference signal associated with a candidate network entity 105 and measuring the indicated reference signal to determine beam information, pathloss information, timing information, or any combination thereof.

In some examples, at 405, a UE 115-c may communicate with a network entity 105-h (e.g., an active serving cell).

In some cases, at 410, the UE 115-c may receive (e.g., from the network entity 105-h) control signaling indicating one or more reference signals associated with the network entity 105-h and indicating a set of candidate reference signals associated with a set of candidate network entities 105, the set of candidate network entities 105 including at least a network entity 105-g.

At 415, the UE 115-c may detect beam failure (e.g., a beam failure event) based on the one or more reference signals associated with the network entity 105-h. That is, the UE 115-c may measure one or more reference signals of the one or more reference signals associated with the network entity 105-h to detect the beam failure.

In some examples, at 420, the UE 115-c may select a reference signal associated with the network entity 105-g from the set of candidate reference signals. For example, the UE 115-c may measure each reference signal (e.g., or one or more reference signals) from the set of candidate reference signals associated with the set of candidate network entities 105 and select the reference signal associated with the network entity 105-g from the set of candidate reference signals based on the measuring (e.g., one or more measurements associated with the set of candidate reference signals.

At 425, the UE 115-c may transmit, to the network entity 105-h, a BFR indicating the reference signal associated with the network entity 105-g based on detecting the beam failure. In some examples, the BFR may include an indication of an identifier associated with the network entity 105-g (e.g., a cell identifier), an index associated with the reference signal associated with the network entity 105-g (e.g., a reference signal identifier), or both. Additionally, or alternatively, the UE 115-c may transmit the BFR via MAC-CE signaling or PRACH signaling.

In some examples, the UE 115-c may transmit the BFR via one or more resources. That is, the UE 115-c may receive second control signaling indicating the one or more resources associated with the BFR such that the UE 115-c may transmit the BFR via the one or more indicated resources.

At 430, the UE 115-c may receive, from the network entity 105-h, third control signaling in response to the BFR, the third control signaling indicating for the UE 115-c to switch communications with the network entity 105-h to the network entity 105-g. In some examples, the second control signaling may be a BFR response or a cell switching command (e.g., L1 or L2 cell switching command).

In some cases, at 435, the UE 115-c may receive, from the network entity 105-g, the indicated reference signal.

In some examples, at 440, the UE 115-c may measure the indicated reference signal associated with the network entity 105-g to determine beam information, path loss information, or both, associated with the network entity 105-g. For examples, the UE 115-c may measure the indicated reference signal associated with the network entity 105-g to determine beam information associated with one or more uplink channels, one or more downlink channels, or both, associated with the network entity 105-g. Additionally, or alternatively, the UE 115-c may measure the indicated reference signal associated with the network entity 105-g to determine path loss information associated with one or more uplink channels associated with the network entity 105-g.

Additionally, or alternatively, the UE 115-c may measure the indicated reference signal associated with the network entity 105-g to determine timing information associated with the network entity 105-g. For example, the UE 115-c may measure the indicated reference signal associated with the network entity 105-g e to determine timing information associated with one or more uplink channels associated with the network entity 105-g.

At 445, the UE 115-c may switch communications with the network entity 105-h to the network entity 105-g based on the third control signaling, measuring the reference signal, or both.

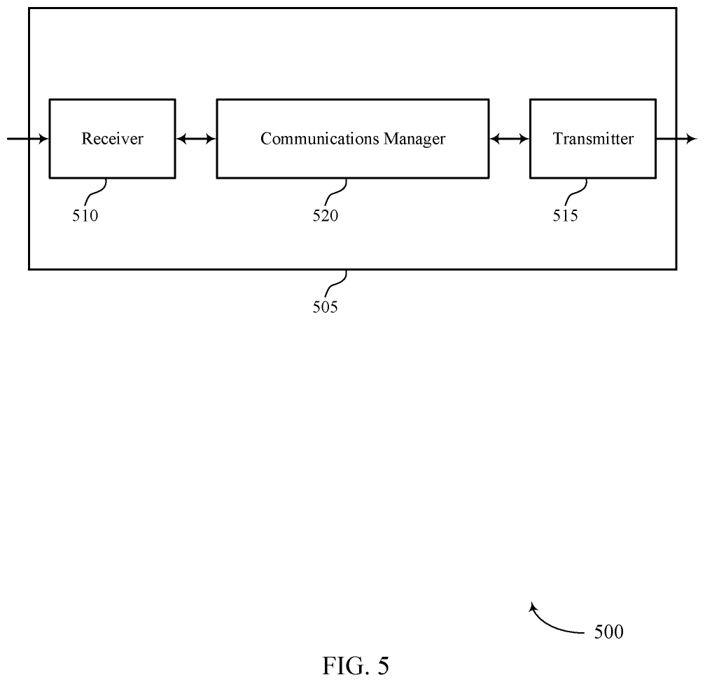

FIG. 5 illustrates a block diagram 500 of a device 505 that supports reference signal indication for a candidate cell in L1/L2 mobility in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to reference signal indication for a candidate cell in L1/L2 mobility). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to reference signal indication for a candidate cell in L1/L2 mobility). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of reference signal indication for a candidate cell in L1/L2 mobility as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 may be configured as or otherwise support a means for receiving, from a first network entity in communication with the UE, an indication of a reference signal associated with a second network entity. The communications manager 520 may be configured as or otherwise support a means for measuring the reference signal associated with the second network entity to determine beam information, path loss information, or both, associated with the second network entity. The communications manager 520 may be configured as or otherwise support a means for switching communications with the first network entity to the second network entity based at least in part on measuring the reference signal.

Additionally, or alternatively, the communications manager 520 may support wireless communications at a UE in accordance with examples as disclosed herein. For example, the communications manager 520 may be configured as or otherwise support a means for detecting beam failure based at least in part on one or more reference signals associated with a first network entity, wherein the UE is in communication with the first network entity. The communications manager 520 may be configured as or otherwise support a means for transmitting, to the first network entity, a BFR indicating a reference signal associated with a second network entity based at least in part on detecting the beam failure. The communications manager 520 may be configured as or otherwise support a means for receiving, from the first network entity, control signaling in response to the BFR, the control signaling indicating for the UE to switch communications with the first network entity to the second network entity. The communications manager 520 may be configured as or otherwise support a means for switching communications with the first network entity to the second network entity based at least in part on receiving the control signaling.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for indicating a reference signal associated with a candidate cell in L1/L2 mobility which may result in reduced processing, reduced power consumption, and more efficient utilization of communication resources, among other advantages.

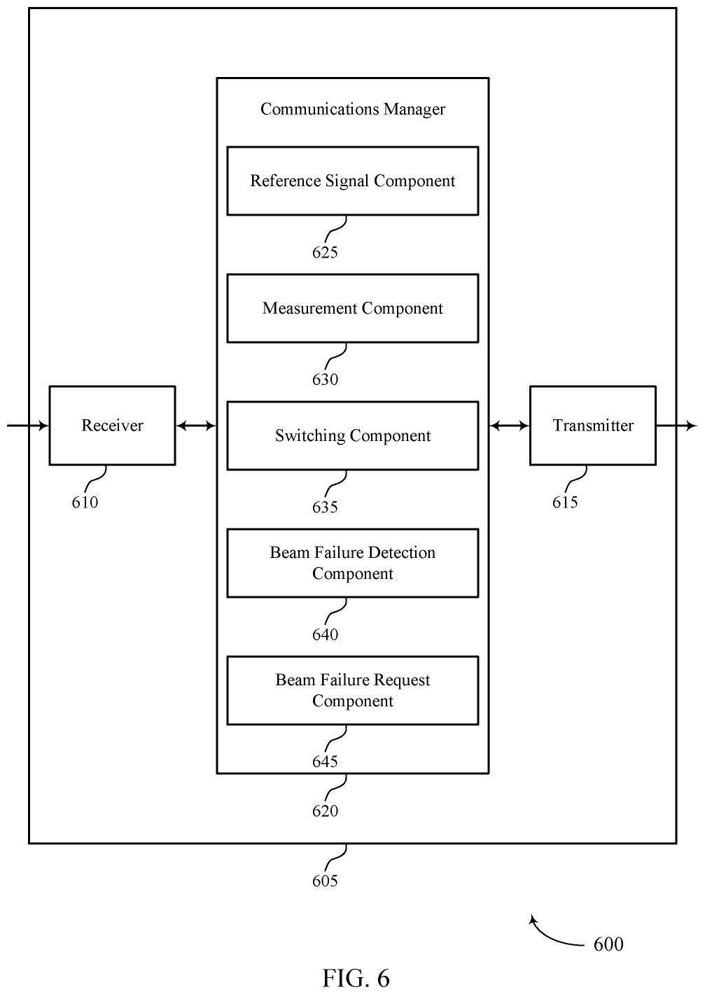

FIG. 6 illustrates a block diagram 600 of a device 605 that supports reference signal indication for a candidate cell in L1/L2 mobility in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to reference signal indication for a candidate cell in L1/L2 mobility). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to reference signal indication for a candidate cell in L1/L2 mobility). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of reference signal indication for a candidate cell in L1/L2 mobility as described herein. For example, the communications manager 620 may include a reference signal component 625, a measurement component 630, a switching component 635, a beam failure detection component 640, a BFR component 645, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The reference signal component 625 may be configured as or otherwise support a means for receiving, from a first network entity in communication with the UE, an indication of a reference signal associated with a second network entity. The measurement component 630 may be configured as or otherwise support a means for measuring the reference signal associated with the second network entity to determine beam information, path loss information, or both, associated with the second network entity. The switching component 635 may be configured as or otherwise support a means for switching communications with the first network entity to the second network entity based at least in part on measuring the reference signal.

Additionally, or alternatively, the communications manager 620 may support wireless communications at a UE in accordance with examples as disclosed herein. The beam failure detection component 640 may be configured as or otherwise support a means for detecting beam failure based at least in part on one or more reference signals associated with a first network entity, wherein the UE is in communication with the first network entity. The BFR component 645 may be configured as or otherwise support a means for transmitting, to the first network entity, a BFR indicating a reference signal associated with a second network entity based at least in part on detecting the beam failure. The switching component 635 may be configured as or otherwise support a means for receiving, from the first network entity, control signaling in response to the BFR, the control signaling indicating for the UE to switch communications with the first network entity to the second network entity. The switching component 635 may be configured as or otherwise support a means for switching communications with the first network entity to the second network entity based at least in part on receiving the control signaling.

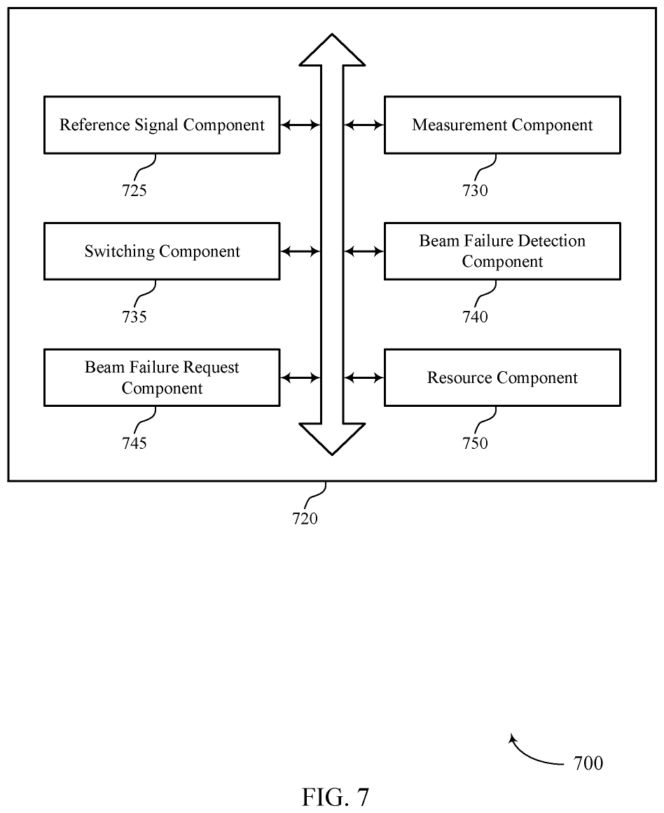

FIG. 7 illustrates a block diagram 700 of a communications manager 720 that supports reference signal indication for a candidate cell in L1/L2 mobility in accordance with one or more aspects of the present disclosure. The communications manager 720 may be an example of aspects of a communications manager 520, a communications manager 620, or both, as described herein. The communications manager 720, or various components thereof, may be an example of means for performing various aspects of reference signal indication for a candidate cell in L1/L2 mobility as described herein. For example, the communications manager 720 may include a reference signal component 725, a measurement component 730, a switching component 735, a beam failure detection component 740, a BFR component 745, a resource component 750, or any combination thereof. Each of these components may communicate, directly or indirectly, with one another (e.g., via one or more buses).

The communications manager 720 may support wireless communications at a UE in accordance with examples as disclosed herein. The reference signal component 725 may be configured as or otherwise support a means for receiving, from a first network entity in communication with the UE, an indication of a reference signal associated with a second network entity. The measurement component 730 may be configured as or otherwise support a means for measuring the reference signal associated with the second network entity to determine beam information, path loss information, or both, associated with the second network entity. The switching component 735 may be configured as or otherwise support a means for switching communications with the first network entity to the second network entity based at least in part on measuring the reference signal.

In some examples, the switching component 735 may be configured as or otherwise support a means for receiving, from the first network entity, control signaling indicating for the UE to switch communications with the first network entity to the second network entity, wherein switching communications with the first network entity to the second network entity is based at least in part on receiving the control signaling.

In some examples, the control signaling includes the indication of the reference signal associated with the second network entity.

In some examples, the control signaling is DCI signaling or MAC-CE signaling.

In some examples, the UE receives the indication of the reference signal associated with the second network entity prior to receiving the control signaling.

In some examples, the indication of the reference signal associated with the second network entity is received via DCI signaling, MAC-CE signaling, or RRC signaling.

In some examples, the indication of the reference signal includes an indication of a SSB, a CSI-RS, a TRS, an identifier associated with the second network entity, or any combination thereof.

In some examples, to support measuring the reference signal associated with the second network entity, the measurement component 730 may be configured as or otherwise support a means for measuring the reference signal to determine timing information associated with the second network entity.

In some examples, the timing information is downlink timing information associated with one or more uplink channels further associated with the second network entity.

In some examples, to support measuring the reference signal associated with the second network entity, the measurement component 730 may be configured as or otherwise support a means for measuring the reference signal associated with the second network entity to determine the beam information associated with one or more uplink channels, one or more downlink channels, or both, further associated with the second network entity.

In some examples, to support measuring the reference signal associated with the second network entity, the measurement component 730 may be configured as or otherwise support a means for measuring the reference signal associated with the second network entity to determine the path loss information associated with one or more uplink channels further associated with the second network entity.

Additionally, or alternatively, the communications manager 720 may support wireless communications at a UE in accordance with examples as disclosed herein. The beam failure detection component 740 may be configured as or otherwise support a means for detecting beam failure based at least in part on one or more reference signals associated with a first network entity, wherein the UE is in communication with the first network entity. The BFR component 745 may be configured as or otherwise support a means for transmitting, to the first network entity, a BFR indicating a reference signal associated with a second network entity based at least in part on detecting the beam failure. In some examples, the switching component 735 may be configured as or otherwise support a means for receiving, from the first network entity, control signaling in response to the BFR, the control signaling indicating for the UE to switch communications with the first network entity to the second network entity. In some examples, the switching component 735 may be configured as or otherwise support a means for switching communications with the first network entity to the second network entity based at least in part on receiving the control signaling.

In some examples, the beam failure detection component 740 may be configured as or otherwise support a means for receiving second control signaling indicating the one or more reference signals associated with the first network entity and indicating a set of candidate reference signals associated with a set of candidate network entities, the set of candidate network entities including at least the second network entity.

In some examples, the reference signal component 725 may be configured as or otherwise support a means for selecting the reference signal associated with the second network entity from the set of candidate reference signals, wherein transmitting the BFR is based at least in part on the selecting.

In some examples, the measurement component 730 may be configured as or otherwise support a means for measuring each reference signal from the set of candidate reference signals associated with the set of candidate network entities, wherein selecting the reference signal associated with the second network entity is based at least in part on the measuring.

In some examples, the measurement component 730 may be configured as or otherwise support a means for measuring the reference signal associated with the second network entity to determine beam information, path loss information, timing information, or any combination thereof, associated with the second network entity.

In some examples, to support measuring the reference signal associated with the second network entity, the measurement component 730 may be configured as or otherwise support a means for measuring the reference signal associated with the second network entity to determine the beam information associated with one or more uplink channels, one or more downlink channels, or both, further associated with the second network entity.

In some examples, to support measuring the reference signal associated with the second network entity, the measurement component 730 may be configured as or otherwise support a means for measuring the reference signal associated with the second network entity to determine the path loss information associated with one or more uplink channels further associated with the second network entity.

In some examples, to support measuring the reference signal associated with the second network entity, the measurement component 730 may be configured as or otherwise support a means for measuring the reference signal associated with the second network entity to determine downlink timing information associated with one or more uplink channels further associated with the second network entity.

In some examples, the BFR includes an indication of an identifier associated with the second network entity, an index associated with the reference signal associated with the second network entity, or both.

In some examples, the BFR is transmitted via MAC-CE signaling or PRACH signaling. In some examples, the control signaling in response to the BFR is a BFR response or a cell switching command. In some examples, the cell switching command is received via L1 signaling or L2 signaling.

In some examples, the resource component 750 may be configured as or otherwise support a means for receiving second control signaling indicating one or more resources associated with the BFR, wherein the BFR is transmitted via the one or more resources.

In some examples, the measurement component 730 may be configured as or otherwise support a means for measuring the one or more reference signals associated with the first network entity, wherein detecting the beam failure is based at least in part on the measuring.

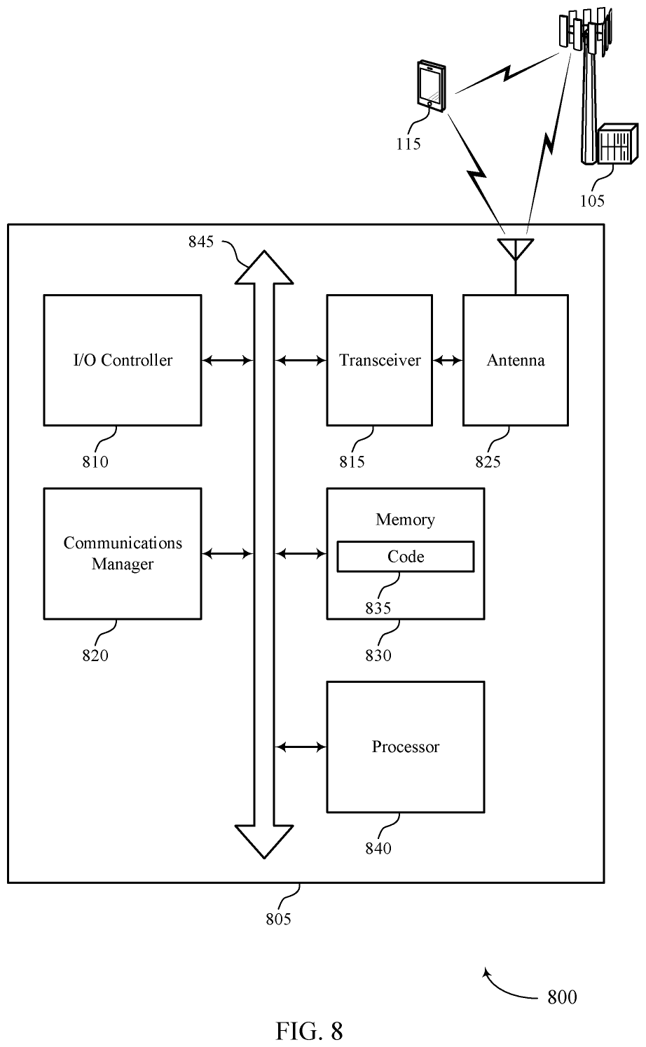

FIG. 8 illustrates a diagram of a system 800 including a device 805 that supports reference signal indication for a candidate cell in L1/L2 mobility in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting reference signal indication for a candidate cell in L1/L2 mobility). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving, from a first network entity in communication with the UE, an indication of a reference signal associated with a second network entity. The communications manager 820 may be configured as or otherwise support a means for measuring the reference signal associated with the second network entity to determine beam information, path loss information, or both, associated with the second network entity. The communications manager 820 may be configured as or otherwise support a means for switching communications with the first network entity to the second network entity based at least in part on measuring the reference signal.

Additionally, or alternatively, the communications manager 820 may support wireless communications at a UE in accordance with examples as disclosed herein. For example, the communications manager 820 may be configured as or otherwise support a means for detecting beam failure based at least in part on one or more reference signals associated with a first network entity, wherein the UE is in communication with the first network entity. The communications manager 820 may be configured as or otherwise support a means for transmitting, to the first network entity, a BFR indicating a reference signal associated with a second network entity based at least in part on detecting the beam failure. The communications manager 820 may be configured as or otherwise support a means for receiving, from the first network entity, control signaling in response to the BFR, the control signaling indicating for the UE to switch communications with the first network entity to the second network entity. The communications manager 820 may be configured as or otherwise support a means for switching communications with the first network entity to the second network entity based at least in part on receiving the control signaling.

By including or configuring the communications manager 820 in accordance with examples as described herein, the device 805 may support techniques for indicating a reference signal associated with a candidate cell in L1/L2 mobility which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of reference signal indication for a candidate cell in L1/L2 mobility as described herein, or the processor 840 and the memory 830 may be otherwise configured to perform or support such operations.

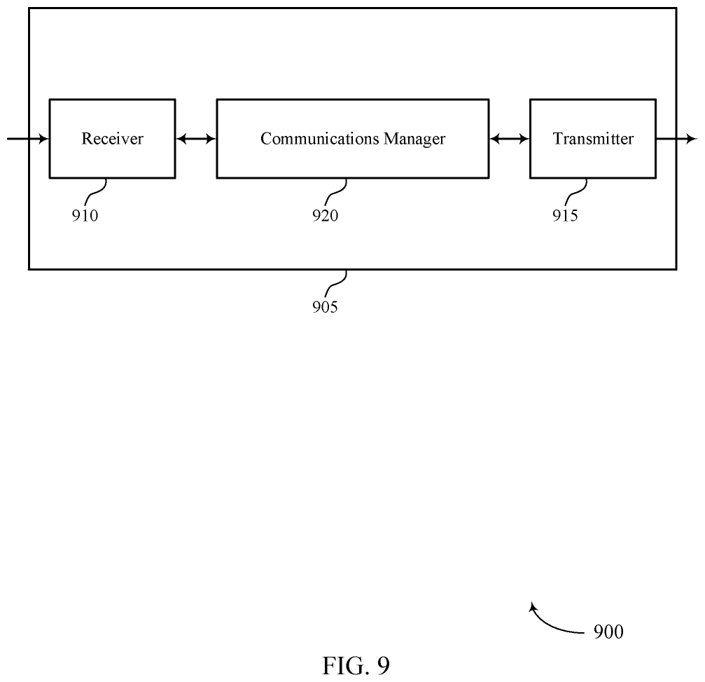

FIG. 9 illustrates a block diagram 900 of a device 905 that supports reference signal indication for a candidate cell in L1/L2 mobility in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of reference signal indication for a candidate cell in L1/L2 mobility as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a first network entity in accordance with examples as disclosed herein. For example, the communications manager 920 may be configured as or otherwise support a means for outputting, to a UE in communication with the first network entity, an indication of a reference signal associating with a second network entity, the reference signal further associated with beam information, path loss information, or both, associated with the second network entity. The communications manager 920 may be configured as or otherwise support a means for releasing communications with the UE based at least in part on outputting the indication.

Additionally, or alternatively, the communications manager 920 may support wireless communications at a first network entity in accordance with examples as disclosed herein. For example, the communications manager 920 may be configured as or otherwise support a means for obtaining, from a UE in communication with the first network entity, a BFR indicating a reference signal associated with a second network entity. The communications manager 920 may be configured as or otherwise support a means for outputting control signaling in response to the BFR, the control signaling indicating for the UE to switch communications with the first network entity to the second network entity. The communications manager 920 may be configured as or otherwise support a means for releasing communications with the UE based at least in part on outputting the control signaling.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for indicating a reference signal associated with a candidate cell in L1/L2 mobility which may result in reduced processing, reduced power consumption, and more efficient utilization of communication resources, among other advantages.

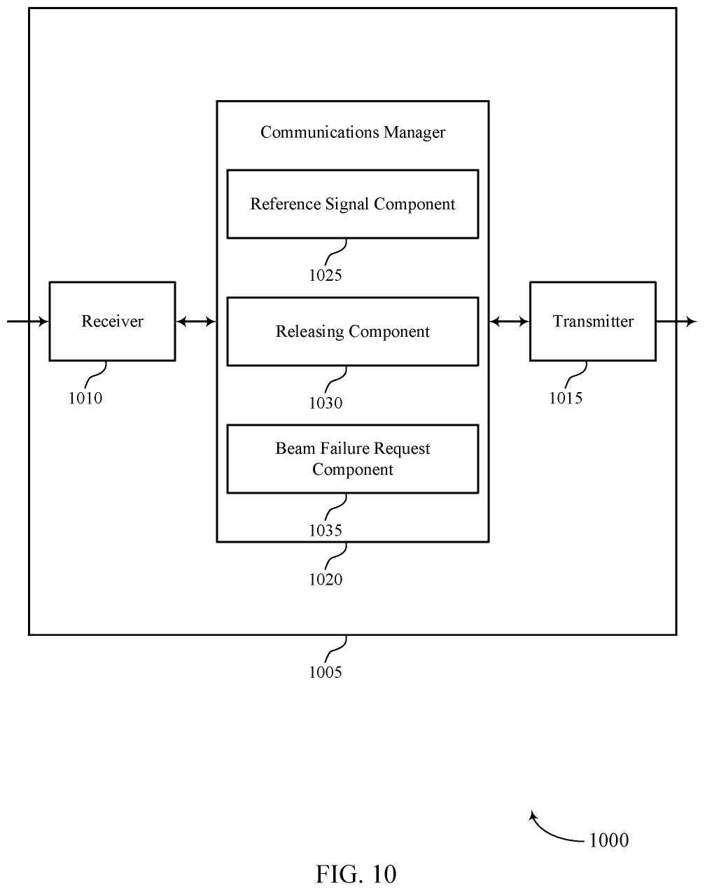

FIG. 10 illustrates a block diagram 1000 of a device 1005 that supports reference signal indication for a candidate cell in L1/L2 mobility in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of reference signal indication for a candidate cell in L1/L2 mobility as described herein. For example, the communications manager 1020 may include a reference signal component 1025, a releasing component 1030, a BFR component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a first network entity in accordance with examples as disclosed herein. The reference signal component 1025 may be configured as or otherwise support a means for outputting, to a UE in communication with the first network entity, an indication of a reference signal associated with a second network entity, the reference signal further associated with beam information, path loss information, or both, associated with the second network entity. The releasing component 1030 may be configured as or otherwise support a means for releasing communications with the UE based at least in part on outputting the indication.

Additionally, or alternatively, the communications manager 1020 may support wireless communications at a first network entity in accordance with examples as disclosed herein. The BFR component 1035 may be configured as or otherwise support a means for obtaining, from a UE in communication with the first network entity, a BFR indicating a reference signal associated with a second network entity. The releasing component 1030 may be configured as or otherwise support a means for outputting control signaling in response to the BFR, the control signaling indicating for the UE to switch communications with the first network entity to the second network entity. The releasing component 1030 may be configured as or otherwise support a means for releasing communications with the UE based at least in part on outputting the control signaling.

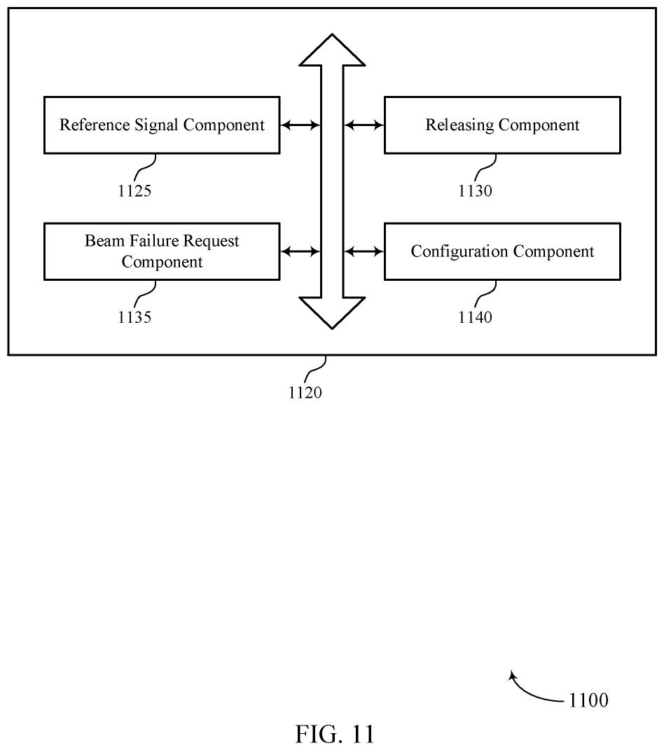

FIG. 11 illustrates a block diagram 1100 of a communications manager 1120 that supports reference signal indication for a candidate cell in L1/L2 mobility in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of reference signal indication for a candidate cell in L1/L2 mobility as described herein. For example, the communications manager 1120 may include a reference signal component 1125, a releasing component 1130, a BFR component 1135, a configuration component 1140, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a first network entity in accordance with examples as disclosed herein. The reference signal component 1125 may be configured as or otherwise support a means for outputting, to a UE in communication with the first network entity, an indication of a reference signal associated with a second network entity, the reference signal further associated with beam information, path loss information, or both, associated with the second network entity. The releasing component 1130 may be configured as or otherwise support a means for releasing communications with the UE based at least in part on outputting the indication.

In some examples, the releasing component 1130 may be configured as or otherwise support a means for outputting control signaling indicating for the UE to switch communications with the first network entity to the second network entity, wherein releasing communications with the UE is based at least in part on outputting the control signaling.

In some examples, the control signaling includes the indication of the reference signal associated with the second network entity. In some examples, the control signaling is DCI signaling or MAC-CE signaling.

In some examples, the first network entity outputs the indication of the reference signal associated with the second network entity prior to outputting the control signaling. In some examples, the indication of the reference signal associated with the second network entity is outputted via DCI signaling, MAC-CE signaling, or RRC signaling.

In some examples, the indication of the reference signal includes an indication of a SSB, a CSI-RS, a TRS, an identifier associated with a bandwidth part further associated with the second network entity, a cell identifier associated with the second network entity, or any combination thereof.

In some examples, the reference signal associated with the second network entity is further associated with timing information associated with the second network entity. In some examples, the timing information is downlink timing information associated with one or more uplink channels further associated with the second network entity.

In some examples, the beam information is associated with one or more uplink channels, one or more downlink channels, or both, further associated with the second network entity. In some examples, the path loss information is associated with one or more uplink channels further associated with the second network entity.

Additionally, or alternatively, the communications manager 1120 may support wireless communications at a first network entity in accordance with examples as disclosed herein. The BFR component 1135 may be configured as or otherwise support a means for obtaining, from a UE in communication with the first network entity, a BFR indicating a reference signal associated with a second network entity. In some examples, the releasing component 1130 may be configured as or otherwise support a means for outputting control signaling in response to the BFR, the control signaling indicating for the UE to switch communications with the first network entity to the second network entity. In some examples, the releasing component 1130 may be configured as or otherwise support a means for releasing communications with the UE based at least in part on outputting the control signaling.

In some examples, the configuration component 1140 may be configured as or otherwise support a means for outputting second control signaling indicating one or more reference signals associated with the first network entity and indicating a set of candidate reference signals associated with a set of candidate network entities, the set of candidate network entities including at least the second network entity.

In some examples, the BFR includes an indication of an identifier associated with the second network entity, an index associated with the reference signal associated with the second network entity, or both.

In some examples, the BFR is obtained via a MAC-CE or PRACH signaling.

In some examples, the control signaling in response to the BFR is a BFR response or a cell switching command.

In some examples, the cell switching command is outputted via L1 signaling or L2 signaling.

In some examples, the configuration component 1140 may be configured as or otherwise support a means for transmitting second control signaling indicating one or more resources associated with the BFR, wherein the BFR is obtained via the one or more resources.

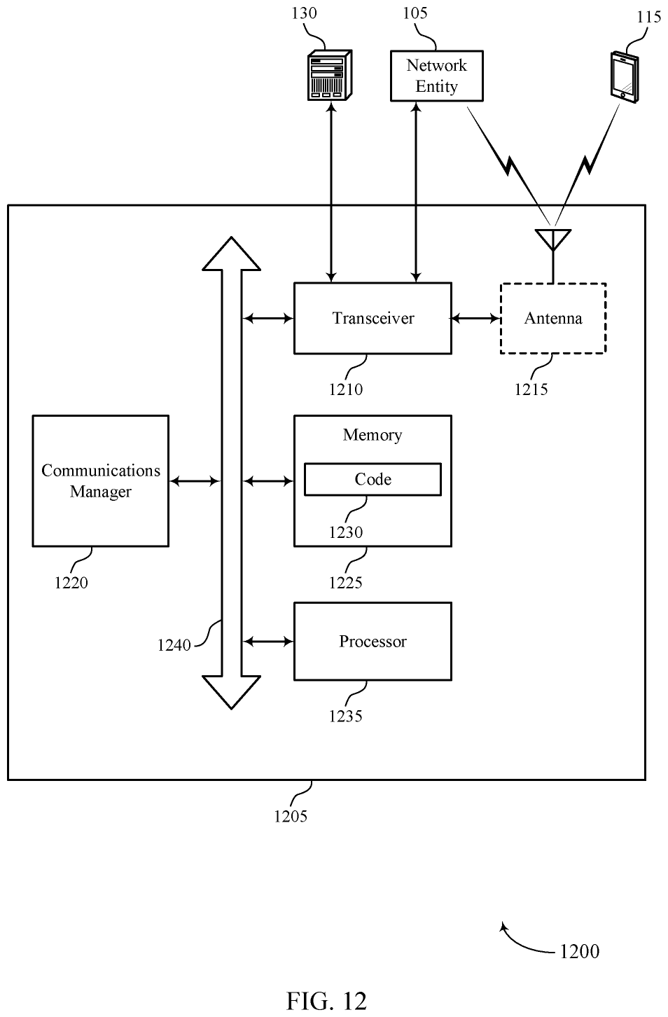

FIG. 12 illustrates a diagram of a system 1200 including a device 1205 that supports reference signal indication for a candidate cell in L1/L2 mobility in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based at least in part on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting reference signal indication for a candidate cell in L1/L2 mobility). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., wherein the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a first network entity in accordance with examples as disclosed herein. For example, the communications manager 1220 may be configured as or otherwise support a means for outputting, to a UE in communication with the first network entity, an indication of a reference signal associating with a second network entity, the reference signal further associated with beam information, path loss information, or both, associated with the second network entity. The communications manager 1220 may be configured as or otherwise support a means for releasing communications with the UE based at least in part on outputting the indication.

Additionally, or alternatively, the communications manager 1220 may support wireless communications at a first network entity in accordance with examples as disclosed herein. For example, the communications manager 1220 may be configured as or otherwise support a means for obtaining, from a UE in communication with the first network entity, a BFR indicating a reference signal associated with a second network entity. The communications manager 1220 may be configured as or otherwise support a means for outputting control signaling in response to the BFR, the control signaling indicating for the UE to switch communications with the first network entity to the second network entity. The communications manager 1220 may be configured as or otherwise support a means for releasing communications with the UE based at least in part on outputting the control signaling.

By including or configuring the communications manager 1220 in accordance with examples as described herein, the device 1205 may support techniques for indicating a reference signal associated with a candidate cell in L1/L2 mobility which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., wherein applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of reference signal indication for a candidate cell in L1/L2 mobility as described herein, or the processor 1235 and the memory 1225 may be otherwise configured to perform or support such operations.

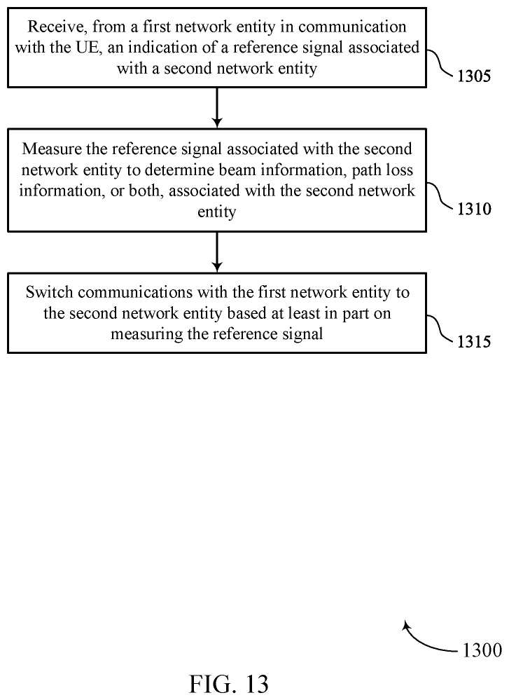

FIG. 13 illustrates a flowchart illustrating a method 1300 that supports reference signal indication for a candidate cell in L1/L2 mobility in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, from a first network entity in communication with the UE, an indication of a reference signal associated with a second network entity. The operations of 1305 may be performed in accordance with examples as disclosed herein. In some examples, aspects of the operations of 1305 may be performed by a reference signal component 725 as described with reference to FIG. 7.

At 1310, the method may include measuring the reference signal associated with the second network entity to determine beam information, path loss information, or both, associated with the second network entity. The operations of 1310 may be performed in accordance with examples as disclosed herein. In some examples, aspects of the operations of 1310 may be performed by a measurement component 730 as described with reference to FIG. 7.

At 1315, the method may include switching communications with the first network entity to the second network entity based at least in part on measuring the reference signal. The operations of 1315 may be performed in accordance with examples as disclosed herein. In some examples, aspects of the operations of 1315 may be performed by a switching component 735 as described with reference to FIG. 7.

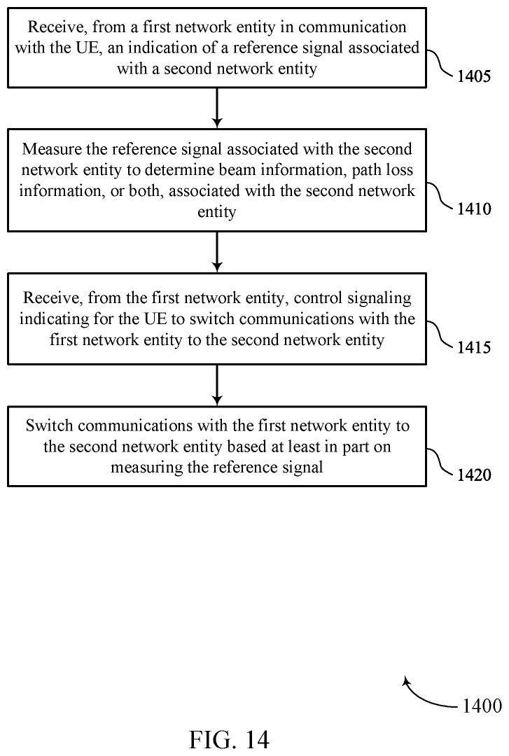

FIG. 14 illustrates a flowchart illustrating a method 1400 that supports reference signal indication for a candidate cell in L1/L2 mobility in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, from a first network entity in communication with the UE, an indication of a reference signal associated with a second network entity. The operations of 1405 may be performed in accordance with examples as disclosed herein. In some examples, aspects of the operations of 1405 may be performed by a reference signal component 725 as described with reference to FIG. 7.

At 1410, the method may include measuring the reference signal associated with the second network entity to determine beam information, path loss information, or both, associated with the second network entity. The operations of 1410 may be performed in accordance with examples as disclosed herein. In some examples, aspects of the operations of 1410 may be performed by a measurement component 730 as described with reference to FIG. 7.

At 1415, the method may include receiving, from the first network entity, control signaling indicating for the UE to switch communications with the first network entity to the second network entity, wherein switching communications with the first network entity to the second network entity is based at least in part on receiving the control signaling. The operations of 1415 may be performed in accordance with examples as disclosed herein. In some examples, aspects of the operations of 1415 may be performed by a switching component 735 as described with reference to FIG. 7.

At 1420, the method may include switching communications with the first network entity to the second network entity based at least in part on measuring the reference signal. The operations of 1420 may be performed in accordance with examples as disclosed herein. In some examples, aspects of the operations of 1420 may be performed by a switching component 735 as described with reference to FIG. 7.

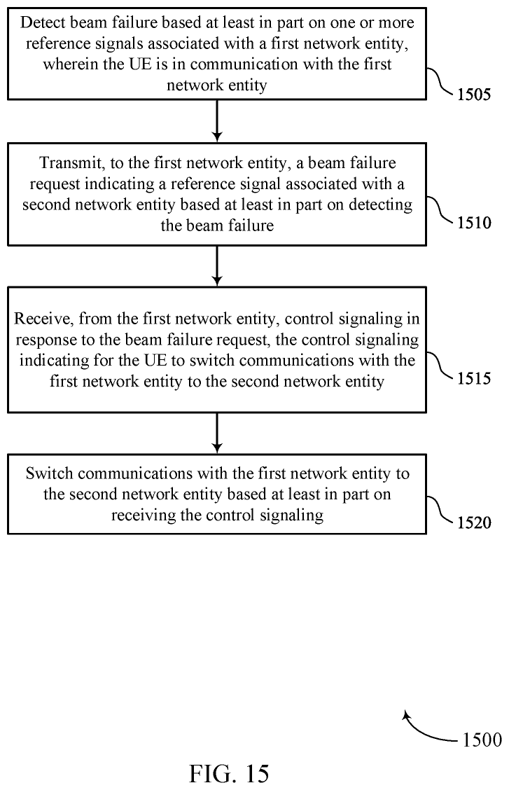

FIG. 15 illustrates a flowchart illustrating a method 1500 that supports reference signal indication for a candidate cell in L1/L2 mobility in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include detecting beam failure based at least in part on one or more reference signals associated with a first network entity, wherein the UE is in communication with the first network entity. The operations of 1505 may be performed in accordance with examples as disclosed herein. In some examples, aspects of the operations of 1505 may be performed by a beam failure detection component 740 as described with reference to FIG. 7.

At 1510, the method may include transmitting, to the first network entity, a BFR indicating a reference signal associated with a second network entity based at least in part on detecting the beam failure. The operations of 1510 may be performed in accordance with examples as disclosed herein. In some examples, aspects of the operations of 1510 may be performed by a BFR component 745 as described with reference to FIG. 7.

At 1515, the method may include receiving, from the first network entity, control signaling in response to the BFR, the control signaling indicating for the UE to switch communications with the first network entity to the second network entity. The operations of 1515 may be performed in accordance with examples as disclosed herein. In some examples, aspects of the operations of 1515 may be performed by a switching component 735 as described with reference to FIG. 7.

At 1520, the method may include switching communications with the first network entity to the second network entity based at least in part on receiving the control signaling. The operations of 1520 may be performed in accordance with examples as disclosed herein. In some examples, aspects of the operations of 1520 may be performed by a switching component 735 as described with reference to FIG. 7.

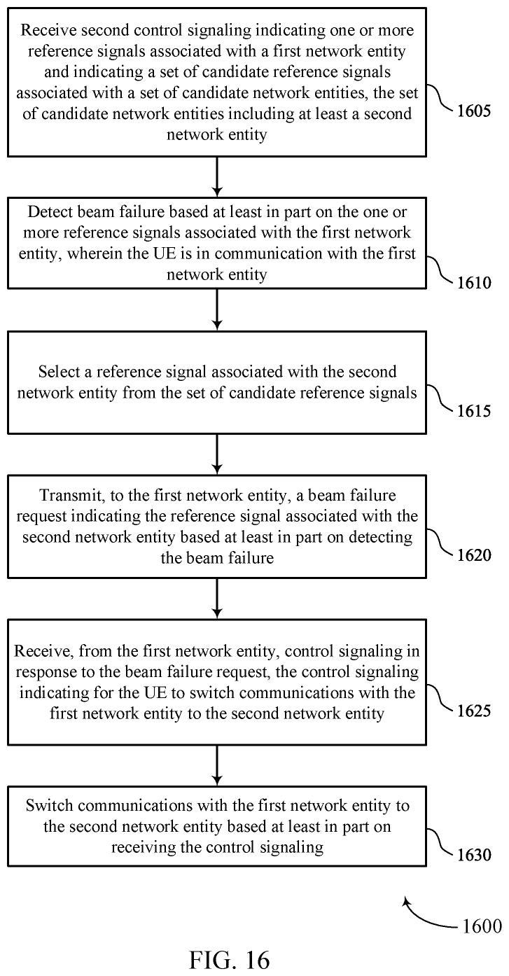

FIG. 16 illustrates a flowchart illustrating a method 1600 that supports reference signal indication for a candidate cell in L1/L2 mobility in accordance with one or more aspects of the present disclosure. The operations of the method 1600 may be implemented by a UE or its components as described herein. For example, the operations of the method 1600 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1605, the method may include receiving second control signaling indicating the one or more reference signals associated with the first network entity and indicating a set of candidate reference signals associated with a set of candidate network entities, the set of candidate network entities including at least the second network entity. The operations of 1605 may be performed in accordance with examples as disclosed herein. In some examples, aspects of the operations of 1605 may be performed by a beam failure detection component 740 as described with reference to FIG. 7.

At 1610, the method may include detecting beam failure based at least in part on one or more reference signals associated with a first network entity, wherein the UE is in communication with the first network entity. The operations of 1610 may be performed in accordance with examples as disclosed herein. In some examples, aspects of the operations of 1610 may be performed by a beam failure detection component 740 as described with reference to FIG. 7.

At 1615, the method may include selecting the reference signal associated with the second network entity from the set of candidate reference signals, wherein transmitting the BFR is based at least in part on the selecting. The operations of 1615 may be performed in accordance with examples as disclosed herein. In some examples, aspects of the operations of 1615 may be performed by a reference signal component 725 as described with reference to FIG. 7.

At 1620, the method may include transmitting, to the first network entity, a BFR indicating a reference signal associated with a second network entity based at least in part on detecting the beam failure. The operations of 1620 may be performed in accordance with examples as disclosed herein. In some examples, aspects of the operations of 1620 may be performed by a BFR component 745 as described with reference to FIG. 7.

At 1625, the method may include receiving, from the first network entity, control signaling in response to the BFR, the control signaling indicating for the UE to switch communications with the first network entity to the second network entity. The operations of 1625 may be performed in accordance with examples as disclosed herein. In some examples, aspects of the operations of 1625 may be performed by a switching component 735 as described with reference to FIG. 7.

At 1630, the method may include switching communications with the first network entity to the second network entity based at least in part on receiving the control signaling. The operations of 1630 may be performed in accordance with examples as disclosed herein. In some examples, aspects of the operations of 1630 may be performed by a switching component 735 as described with reference to FIG. 7.

The following provides an overview of aspects of the present disclosure:
Aspect 1: A method for wireless communications at a UE comprising: receiving, from a first network entity in communication with the UE, an indication of a reference signal associated with a second network entity; measuring the reference signal associated with the second network entity to determine beam information, path loss information, or both, associated with the second network entity; and switching communications with the first network entity to the second network entity based at least in part on measuring the reference signal.
Aspect 2: The method of aspect 1, further comprising: receiving, from the first network entity, control signaling indicating for the UE to switch communications with the first network entity to the second network entity, wherein switching communications with the first network entity to the second network entity is based at least in part on receiving the control signaling.
Aspect 3: The method of aspect 2, wherein the control signaling comprises the indication of the reference signal associated with the second network entity.
Aspect 4: The method of aspect 3, wherein the control signaling is DCI signaling or MAC-CE signaling.
Aspect 5: The method of aspect 2, wherein the UE receives the indication of the reference signal associated with the second network entity prior to receiving the control signaling.
Aspect 6: The method of any of aspects 1 through 5, wherein the indication of the reference signal associated with the second network entity is received via DCI signaling, MAC-CE signaling, or RRC signaling.
Aspect 7: The method of any of aspects 1 through 6, wherein the indication of the reference signal comprises an indication of a SSB, a CSI-RS, a TRS, an identifier associated with the second network entity, or any combination thereof.
Aspect 8: The method of any of aspects 1 through 7, wherein measuring the reference signal associated with the second network entity further comprises: measuring the reference signal to determine timing information associated with the second network entity.
Aspect 9: The method of aspect 8, wherein the timing information is downlink timing information associated with one or more uplink channels further associated with the second network entity.
Aspect 10: The method of any of aspects 1 through 9, wherein measuring the reference signal associated with the second network entity comprises: measuring the reference signal associated with the second network entity to determine the beam information associated with one or more uplink channels, one or more downlink channels, or both, further associated with the second network entity.
Aspect 11: The method of any of aspects 1 through 10, wherein measuring the reference signal associated with the second network entity comprises: measuring the reference signal associated with the second network entity to determine the path loss information associated with one or more uplink channels further associated with the second network entity.
Aspect 12: A method for wireless communications at a first network entity, comprising: outputting, to a UE in communication with the first network entity, an indication of a reference signal associated with a second network entity, the reference signal further associated with beam information, path loss information, or both, associated with the second network entity; and releasing communications with the UE based at least in part on outputting the indication.
Aspect 13: The method of aspect 12, further comprising: outputting control signaling indicating for the UE to switch communications with the first network entity to the second network entity, wherein releasing communications with the UE is based at least in part on outputting the control signaling.
Aspect 14: The method of aspect 13, wherein the control signaling comprises the indication of the reference signal associated with the second network entity.
Aspect 15: The method of aspect 14, wherein the control signaling is DCI signaling or MAC-CE signaling.
Aspect 16: The method of aspect 13, wherein the first network entity outputs the indication of the reference signal associated with the second network entity prior to outputting the control signaling.
Aspect 17: The method of any of aspects 12 through 16, wherein the indication of the reference signal associated with the second network entity is outputted via DCI signaling, MAC-CE signaling, or RRC signaling.
Aspect 18: The method of any of aspects 12 through 17, wherein the indication of the reference signal comprises an indication of a SSB, a CSI-RS, a TRS, an identifier associated with a BWP further associated with the second network entity, a cell identifier associated with the second network entity, or any combination thereof.
Aspect 19: The method of any of aspects 12 through 18, wherein the reference signal associated with the second network entity is further associated with timing information associated with the second network entity.
Aspect 20: The method of aspect 19, wherein the timing information is downlink timing information associated with one or more uplink channels further associated with the second network entity.
Aspect 21: The method of any of aspects 12 through 20, wherein the beam information is associated with one or more uplink channels, one or more downlink channels, or both, further associated with the second network entity.
Aspect 22: The method of any of aspects 12 through 21, wherein the path loss information is associated with one or more uplink channels further associated with the second network entity.
Aspect 23: A method for wireless communications at a UE, comprising: detecting beam failure based at least in part on one or more reference signals associated with a first network entity, wherein the UE is in communication with the first network entity; transmitting, to the first network entity, a BFR indicating a reference signal associated with a second network entity based at least in part on detecting the beam failure; receiving, from the first network entity, control signaling in response to the BFR, the control signaling indicating for the UE to switch communications with the first network entity to the second network entity; and switching communications with the first network entity to the second network entity based at least in part on receiving the control signaling.
Aspect 24: The method of aspect 23, further comprising: receiving second control signaling indicating the one or more reference signals associated with the first network entity and indicating a set of candidate reference signals associated with a set of candidate network entities, the set of candidate network entities including at least the second network entity.
Aspect 25: The method of aspect 24, further comprising: selecting the reference signal associated with the second network entity from the set of candidate reference signals, wherein transmitting the BFR is based at least in part on the selecting.
Aspect 26: The method of aspect 25, further comprising: measuring each reference signal from the set of candidate reference signals associated with the set of candidate network entities, wherein selecting the reference signal associated with the second network entity is based at least in part on the measuring.
Aspect 27: The method of any of aspects 23 through 26, further comprising: measuring the reference signal associated with the second network entity to determine beam information, path loss information, timing information, or any combination thereof, associated with the second network entity.
Aspect 28: The method of aspect 27, wherein measuring the reference signal associated with the second network entity comprises: measuring the reference signal associated with the second network entity to determine the beam information associated with one or more uplink channels, one or more downlink channels, or both, further associated with the second network entity.
Aspect 29: The method of any of aspects 27 through 28, wherein measuring the reference signal associated with the second network entity comprises: measuring the reference signal associated with the second network entity to determine the path loss information associated with one or more uplink channels further associated with the second network entity.
Aspect 30: The method of any of aspects 27 through 29, wherein measuring the reference signal associated with the second network entity comprises: measuring the reference signal associated with the second network entity to determine the downlink timing information associated with one or more uplink channels further associated with the second network entity.
Aspect 31: The method of any of aspects 23 through 30, wherein the BFR comprises an indication of an identifier associated with the second network entity, an index associated with the reference signal associated with the second network entity, or both.
Aspect 32: The method of any of aspects 23 through 31, wherein the BFR is transmitted via MAC-CE signaling or PRACH signaling.
Aspect 33: The method of any of aspects 23 through 32, wherein the control signaling in response to the BFR is a BFR response or a cell switching command.
Aspect 34: The method of aspect 33, wherein the cell switching command is received via L1 signaling or L2 signaling.
Aspect 35: The method of any of aspects 23 through 34, further comprising: receiving second control signaling indicating one or more resources associated with the BFR, wherein the BFR is transmitted via the one or more resources.
Aspect 36: The method of any of aspects 23 through 35, further comprising: measuring the one or more reference signals associated with the first network entity, wherein detecting the beam failure is based at least in part on the measuring.
Aspect 37: A method for wireless communications at a first network entity, comprising: obtaining, from a UE in communication with the first network entity, a BFR indicating a reference signal associated with a second network entity; outputting control signaling in response to the BFR, the control signaling indicating for the UE to switch communications with the first network entity to the second network entity; and releasing communications with the UE based at least in part on outputting the control signaling.
Aspect 38: The method of aspect 37, further comprising: outputting second control signaling indicating one or more reference signals associated with the first network entity and indicating a set of candidate reference signals associated with a set of candidate network entities, the set of candidate network entities including at least the second network entity.
Aspect 39: The method of any of aspects 37 through 38, wherein the BFR comprises an indication of an identifier associated with the second network entity, an index associated with the reference signal associated with the second network entity, or both.
Aspect 40: The method of any of aspects 37 through 39, wherein the BFR is obtained via a MAC-CE or PRACH signaling.
Aspect 41: The method of any of aspects 37 through 40, wherein the control signaling in response to the BFR is a BFR response or a cell switching command.
Aspect 42: The method of aspect 41, wherein the cell switching command is outputted via L1 signaling or L2 signaling.
Aspect 43: The method of any of aspects 37 through 42, further comprising: transmitting second control signaling indicating one or more resources associated with the BFR, wherein the BFR is obtained via the one or more resources.
Aspect 44: An apparatus for wireless communications at a UE, comprising a processor; memory coupled with the processor; and instructions stored in the memory and executable by the processor to cause the apparatus to perform a method of any of aspects 1 through 11.
Aspect 45: An apparatus for wireless communications at a UE, comprising at least one means for performing a method of any of aspects 1 through 11.
Aspect 46: A non-transitory computer-readable medium storing code for wireless communications at a UE, the code comprising instructions executable by a processor to perform a method of any of aspects 1 through 11.
Aspect 47: An apparatus for wireless communications at a first network entity, comprising a processor; memory coupled with the processor; and instructions stored in the memory and executable by the processor to cause the apparatus to perform a method of any of aspects 12 through 22.
Aspect 48: An apparatus for wireless communications at a first network entity, comprising at least one means for performing a method of any of aspects 12 through 22.
Aspect 49: A non-transitory computer-readable medium storing code for wireless communications at a first network entity, the code comprising instructions executable by a processor to perform a method of any of aspects 12 through 22.
Aspect 50: An apparatus for wireless communications at a UE, comprising a processor; memory coupled with the processor; and instructions stored in the memory and executable by the processor to cause the apparatus to perform a method of any of aspects 23 through 36.
Aspect 51: An apparatus for wireless communications at a UE, comprising at least one means for performing a method of any of aspects 23 through 36.
Aspect 52: A non-transitory computer-readable medium storing code for wireless communications at a UE, the code comprising instructions executable by a processor to perform a method of any of aspects 23 through 36.
Aspect 53: An apparatus for wireless communications at a first network entity, comprising a processor; memory coupled with the processor; and instructions stored in the memory and executable by the processor to cause the apparatus to perform a method of any of aspects 37 through 43.
Aspect 54: An apparatus for wireless communications at a first network entity, comprising at least one means for performing a method of any of aspects 37 through 43.
Aspect 55: A non-transitory computer-readable medium storing code for wireless communications at a first network entity, the code comprising instructions executable by a processor to perform a method of any of aspects 37 through 43.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communications at a user equipment (UE), comprising:
receiving, from a first network entity in communication with the UE, an indication of a reference signal associated with a second network entity;
measuring the reference signal associated with the second network entity to determine beam information, path loss information, or both, associated with the second network entity; and
switching communications with the first network entity to the second network entity based at least in part on measuring the reference signal.

2. The method of claim 1, further comprising:
receiving, from the first network entity, control signaling indicating for the UE to switch communications with the first network entity to the second network entity, wherein switching communications with the first network entity to the second network entity is based at least in part on receiving the control signaling.

3. The method of claim 2, wherein the control signaling comprises the indication of the reference signal associated with the second network entity.

4. The method of claim 3, wherein the control signaling is downlink control information signaling or medium access control-control element signaling.

5-7. (canceled)

8. The method of claim 1, wherein measuring the reference signal associated with the second network entity further comprises:
measuring the reference signal to determine timing information associated with the second network entity.

9. The method of claim 8, wherein the timing information is downlink timing information associated with one or more uplink channels further associated with the second network entity.

10. (canceled)

11. The method of claim 1, wherein measuring the reference signal associated with the second network entity comprises:
measuring the reference signal associated with the second network entity to determine the path loss information associated with one or more uplink channels further associated with the second network entity.

12. A method for wireless communications at a user equipment (UE), comprising:
detecting beam failure based at least in part on one or more reference signals associated with a first network entity, wherein the UE is in communication with the first network entity;
transmitting, to the first network entity, a beam failure request indicating a reference signal associated with a second network entity based at least in part on detecting the beam failure;
receiving, from the first network entity, control signaling in response to the beam failure request, the control signaling indicating for the UE to switch communications with the first network entity to the second network entity; and
switching communications with the first network entity to the second network entity based at least in part on receiving the control signaling.

13. The method of claim 12, further comprising:
receiving second control signaling indicating the one or more reference signals associated with the first network entity and indicating a set of candidate reference signals associated with a set of candidate network entities, the set of candidate network entities including at least the second network entity.

14. The method of claim 13, further comprising:
selecting the reference signal associated with the second network entity from the set of candidate reference signals, wherein transmitting the beam failure request is based at least in part on the selecting.

15. (canceled)

16. The method of claim 12, further comprising:
measuring the reference signal associated with the second network entity to determine beam information, path loss information, timing information, or any combination thereof, associated with the second network entity.

17. The method of claim 16, wherein measuring the reference signal associated with the second network entity comprises:
measuring the reference signal associated with the second network entity to determine the beam information associated with one or more uplink channels, one or more downlink channels, or both, further associated with the second network entity.

18. The method of claim 16, wherein measuring the reference signal associated with the second network entity comprises:
measuring the reference signal associated with the second network entity to determine the path loss information associated with one or more uplink channels further associated with the second network entity.

19. The method of claim 16, wherein measuring the reference signal associated with the second network entity comprises:
measuring the reference signal associated with the second network entity to determine downlink timing information associated with one or more uplink channels further associated with the second network entity.

20. The method of claim 12, wherein the beam failure request comprises an indication of an identifier associated with the second network entity, an index associated with the reference signal associated with the second network entity, or both.

21. The method of claim 12, wherein the beam failure request is transmitted via medium access control-control element signaling or physical random access channel signaling.

22. The method of claim 12, wherein the control signaling in response to the beam failure request is a beam failure request response or a cell switching command, and wherein the cell switching command is received via level 1 signaling or level 2 signaling

23. (canceled)

24. The method of claim 12, further comprising:
receiving second control signaling indicating one or more resources associated with the beam failure request, wherein the beam failure request is transmitted via the one or more resources.

25. (canceled)

26. An apparatus for wireless communications at a user equipment (UE), comprising:
a processor, and
a memory coupled with the processor, wherein the memory comprises instructions executable by the processor to cause the apparatus to:
receive, from a first network entity in communication with the UE, an indication of a reference signal associated with a second network entity;
measure the reference signal associated with the second network entity to determine beam information, path loss information, or both, associated with the second network entity; and
switch communications with the first network entity to the second network entity based at least in part on measuring the reference signal.

27. The apparatus of claim 26, wherein the instructions are further executable by the processor to cause the apparatus to:
receive, from the first network entity, control signaling indicating for the UE to switch communications with the first network entity to the second network entity, wherein switching communications with the first network entity to the second network entity is based at least in part on receiving the control signaling.

28-30. (canceled)
